(19) United States
(12) Patent Application Publication
(10) Pub. No.: US 2010/0103590 A1
(43) Pub. Date: Apr. 29, 2010

(54) SOLID ELECTROLYTIC CAPACITOR AND PRODUCTION METHOD THEREOF

(75) Inventors: Yoshihiro Saida, Tokyo (JP); Hirofumi Fukunaga, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Minato-ku, TOKYO (JP)

(21) Appl. No.: 11/993,240

(22) PCT Filed: Jun. 27, 2006
(86) PCT No.: PCT/JP2006/313187

§ 371 Date: Dec. 20, 2007

Related U.S. Application Data
(60) Provisional application No. 60/695,541, filed on Jul. 1, 2005.
(60) Provisional application No. 60/719,172, filed on Sep. 22, 2005.

(30) Foreign Application Priority Data
Jun. 27, 2005 (JP) 2005-186909
Sep. 15, 2005 (JP) 2005-268575
May 26, 2006 (JP) 2006-146658

(51) Int. Cl. H01G 9/025

(52) U.S. Cl. 361/525; 427/80

(57) ABSTRACT

The present invention relates to a solid electrolytic capacitor comprising a layer of self-doping type conductive polymer having a crosslink between polymer chains thereof on the dielectric film formed on a valve-acting metal. The present invention enables to stably produce thin capacitor elements suitable for laminated type solid electrolytic capacitors, showing less short-circuit failure and less fluctuation in the shape of element, which allows to increase the number of laminated elements in a solid electrolytic capacitor chip to make a capacitor having a high capacity, and having less fluctuation in equivalent series resistance.

### CROSS REFERENCE TO THE RELATED APPLICATIONS

This is an application filed pursuant to 35 U.S.C. Section 111(a) with claiming the benefit of U.S. Provisional Application Ser. No. 60/695,541 filed Jul. 1, 2005 and No. 60/719,172 filed Sep. 22, 2005 under the provision of 35 U.S.C. Section 111(b), pursuant to 35 U.S.C. Section 119(e)(1).

### TECHNICAL FIELD

The present invention relates to a solid electrolytic capacitor containing an electroconductive polymer on a dielectric film and to a method of producing the same.

### BACKGROUND ART

Generally, as shown in FIG. 1, for example, fundamental elements of a solid electrolytic capacitor are fabricated by forming a dielectric oxide film layer (2) on each side of an anode substrate (1) made of an etched metal foil having a relatively large specific surface area, forming solid semiconductor layers (hereinafter, referred to as “solid electrolytes”) (4) as opposite electrodes on both sides of the dielectric oxide film layer (2), and preferably further forming a layer of a conductive material (5) such as a conductive paste thereon. Generally, a masking layer (3) comprising an insulating material is further provided to ensure the insulation between the solid electrolyte layer (4) (a cathode part) and the anode substrate (1). Leads (6, 7) are connected to the individual element or a laminate body of a plurality of elements, and the entire elements are completely sealed with, for example, an epoxy resin (8) and the resultant is used widely as capacitor (9) components in electronic products.

In recent years, along with use of digitalized electronic appliance and higher speed personal computers, there has been a keen demand for capacitors that have a compact size and high capacity and that have a low impedance in a high frequency wavelength region. Lately, it has been proposed to use a conductive polymer having electron conductivity as a solid electrolyte. Generally, as a technique for forming a conductive polymer on a dielectric oxide film, an electrolytic oxidation polymerization method and a chemical oxidation polymerization method are known. While with the chemical oxidation polymerization method, it is difficult to control the reaction or the form of the resultant polymer film, it is easy to form a solid electrolyte, allowing its mass production in a short time, so that various methods have been proposed. For example, a method of forming a solid electrolyte having a lamellar structure by alternately repeating a step of dipping an anode substrate in a solution containing a monomer and a step of dipping the anode substrate in a solution containing an oxidizer has been disclosed (Patent Document 1: Japanese Patent Publication No. 3187380). According to this method, a solid electrolyte layer of a lamellar structure having a thickness of 0.01 μm to 5 μm is formed, which results in the production of a solid electrolytic capacitor having a high capacity, a low impedance, and excellent heat resistance. However, this method has a problem that there is a large space portion in the interlamellar interstices in the lamellar-structured portion that constitutes the solid electrolyte layer. Therefore, a further decrease in the thickness of the entire solid electrolyte layer as an element for use in a laminate-type capacitor that includes a plurality of capacitor elements in the form of a laminate.

As a method of forming a solid electrolyte in pores and on an outer surface of a capacitor element without forming a solid electrolyte layer having a lamellar structure, there has been disclosed a method that involves repeating a cycle of dipping an anode substrate in a solution containing a monomer compound, polymerizing the monomer in an oxidizer solution, washing the resultant polymer to remove the oxidizer, and drying the washed polymer (Patent Document 2: Japanese Patent Publication Laid-Open No. 9-306788). The solid electrolyte layer formed by this method, however, has insufficient resistance to external stress because of absence of space portions between the layers.

As a method of forming a solid electrolyte, there has been disclosed a method of covering a single conductive polymer in the pores and on the outer periphery of the capacitor element, and in addition, a method in which two kinds of conductive polymers are arranged between the anode and the cathode of a capacitor element. That is, there has been proposed a method of producing a solid electrolytic capacitor that has a large capacity and excellent impedance characteristic by repeating dipping in a solution of a water-soluble sulfonated polyaniline and drying to form a first conductive polymer layer, and then performing electrolytic polymerization to form a second conductive polymer layer (Patent Document 3: Japanese Patent Publication Laid-Open No. 10-321474). Further, there has been proposed a method of insolubilizing the first conductive polymer layer by further performing a heat treatment at a high temperature in order to prevent the first conductive polymer from being dissolved when the second conductive polymer is formed (Patent Document 4: Japanese Patent Publication Laid-Open No. 2002-313684).

Meanwhile, with respect to an anode substrate, the insulation/separation between an anode part and a cathode part is essential to produce a solid electrolytic capacitor. Patent Document 5 (Published Japanese Translation of PCT Publication No. 2000-67267) is discloses that insulation/separation is enabled by applying low molecular polyimide or a precursor thereof which is excellent in insulation properties and heat resistance after being cured onto the surface of an anode substrate in which a porous layer is formed.

However, the present inventors have found that the insulation/separation between the anode part and the cathode part by applying an insulating material is still insufficient since the penetration of the insulating material into the porous layer is quite variable. That is, in the process of forming a cathode layer by repeating a step of dipping an anode substrate in a solution containing a monomer and a step of dipping the substrate in a solution containing an oxidizer alternately, the monomer solution and oxidizer solution penetrate from the cathode part through the defective portion in the porous layer formed in the anode substrate where the penetration of the insulating material is insufficient. Consequently, a solid electrolyte layer is formed to the vicinity of the anode and leads to the increase in the leakage current, or a formed solid electrolyte layer comes in contact with the anode and causes a short circuit. Though the present inventors have already found that the insulation properties can be improved by increasing the coating width of the insulating layer used for insulation/separation, it was not preferable since it leads to relative decrease in the dielectric material area which can be effectively utilized in a solid electrolytic capacitor of a predetermined size and thereby lowering the capacity appearance ratio.

[Patent Document 1] Japanese Patent No. 3187380

[Patent Document 2] Japanese Patent Publication Laid-Open No. 9-306788

[Patent Document 3] Japanese Patent Publication Laid-Open No. 10-321474

[Patent Document 4] Japanese Patent Publication Laid-Open No. 2002-313684

[Patent Document 5] Published Japanese Translation of PCT Publication No.2000-67267

### DISCLOSURE OF INVENTION

Sulfonated polyaniline, which is one of self-doing type conductive polymers, has been known to have a low conductivity as compared with polypyrrole and polyethylene dioxythiophene that include exogenous dopants. Therefore, when a dielectric layer is covered with sulfonated polyaniline, the covered dielectric layer has an increased equivalent series resistance as compared with the case where chemical oxidation polymerization or electrochemical polymerization is individually performed and a conductive polymer film of such as a polypyrrole derivative and polyethylenedioxythiophene is used alone as a cover film. Further, the high temperature treatment for insolubilizing the sulfonated polyaniline is accompanied by a release of sulfonate groups and hence de-doping of the conductive polymer, so that the equivalent series resistance of the sulfonated polyaniline increases. Note that both Patent Documents 3 and 4 using sulfonated polyaniline do not mention equivalent series resistance.

On the other hand, to obtain a solid electrolytic capacitor having a predetermined capacity, usually a plurality of capacitor elements is laminated, an anode lead is connected to a terminal of the anode, a cathode lead is connected to a conductive material layer that contains a conductive polymer, and further the entire structure is sealed with an insulating resin such as epoxy resin to fabricate a solid electrolytic capacitor. However, in solid electrolytic capacitors, it is necessary to control polymerization conditions for the conductive polymer such that the thickness of the conductive polymer can have a larger thickness at the cathode portion of the capacitor element. Without precise control of the polymerization conditions for the conductive polymer at the cathode portion of the capacitor element, the conductive polymer will have an uneven thickness so that it will have a thin portion. This makes it easy for pastes or the like to contact the dielectric oxide film layer directly, thus leading to an increase in leakage current. Further, the number of capacitor elements that can be laminated on a solid electrolytic capacitor chip having a predetermined size is limited depending on the thickness of the capacitor element, so that it has been unsuccessful to increase the capacity of solid electrolytic capacitor chips. Furthermore, an uneven thickness with which the conductive polymer is attached causes a decrease in a contact area between the laminated capacitor elements, so that there will arise a problem that the equivalent series resistance (ESR) of the solid electrolytic capacitor chip increases.

Therefore, it is an object of the present invention to solve the above-mentioned problems without an increase in equivalent series resistance and provide a laminate type solid electrolytic capacitor element, which allows to increase the capacity of the chip by stable fabrication of a capacitor element that shows less fluctuation in the shape of the element without increasing short-circuit failure and that is thin, thereby increasing the number of the capacitor elements to be laminated in the solid electrolytic capacitor chip, and which further enables to reduce fluctuation in equivalent series resistance of the chip produced thereof and to eliminate the defective portions with respect to the insulating material formed to ensure insulation/separation between the anode and the cathode without decreasing the capacity of the chip; and a method of producing such a laminate type solid electrolytic capacitor element.

The inventors of the present invention have made extensive studies in view of the above-mentioned problems and as a result, they have found that:
(1) a self-doping type conductive polymer that serves as a precursor of a self-doping type conductive polymer having crosslinks between polymer chains is a soluble conductive polymer and can form a solution having a low viscosity, so that it can easily penetrate into pores formed by etching and surface expansion and cover the dielectric film uniformly to thereby increase the capacity appearance ratio;
(2) the covering of the self-doping type conductive polymer having crosslinks between the polymer chains on a valve-acting metal surface is particularly effective because there occurs no increase in equivalent series resistance;
(3) further, the covering film made of this polymer has high hardness, water resistance and chemical resistance and hence allows to relieve external stresses exerted onto the dielectric film;
(4) in particular, the paste formed for collecting current after the formation of the solid electrolyte is not only prevented from direct contact with the dielectric oxide film layer at the portion of the conductive polymer that has a small thickness, so that leakage current can be prevented from increasing, but also imparted with high heat resistance, so that a useful solid electrolytic capacitor that can endure high reflow temperatures, adapted to a lead-free construction, can be provided;
(5) on the other hand, by having the covered structure according to the present invention, the solution absorbability and/or solution retention ability of the valve metal surface that has no pores can be increased during the process of forming a second solid electrolyte layer, thereby enabling to promote the formation of a uniform polymer film; and
(6) the defective portions with respect to the insulating material provided to ensure insulation/separation between the anode and the cathode can be eliminated and thereby leakage current can be reduced without causing decrease in capacity by forming a self-doping type conductive polymer having crosslink between polymer chains on at least a part of the dielectric film layer on the side of the cathode adjacent to the insulating material provided to ensure the insulation/separation between the anode and the cathode.

The inventors of the present invention have confirmed that the solid electrolytic capacitor thus obtained has an increased adhesion of the solid electrolyte formed on the dielectric material film, and a high capacity, and has small dielectric loss (tanδ), leakage current and failure ratio. Further, the inventors of the present invention have also confirmed that by laminating a plurality of the above-mentioned excellent solid electrolytic capacitor elements, the capacitor can be made compact and have a high capacity, thus accomplishing the present invention as follows.
1. A solid electrolytic capacitor comprising a layer of self-doping type conductive polymer having a crosslink between polymer chains thereof on the dielectric film formed on a valve-acting metal.
2. The solid electrolytic capacitor as described in 1 above, wherein the self-doping type conductive polymer contains a sulfonate group.
3. The solid electrolytic capacitor as described in 2 above, wherein the crosslinks are formed through sulfone bonds and the self-doping type conductive polymer contains a crosslinked structure through a sulfone bond in an amount of 0.01 to 90 mol % based on repeating units of the polymer.
4. The solid electrolytic capacitor as described in any one of 1 to 3 above, wherein the self-doping type conductive polymer is a self-doping type conductive polymer having a sulfonate group in which the polymer chains are crosslinked through a bond having a binding energy that is by 0.5 to 2 eV lower than the binding energy of the sulfonate group as measured by an X-ray photoelectron spectroscopy.
5. The solid electrolytic capacitor as described in any one of 1 to 4 above, wherein the self-doping type conductive polymer contains isothianaphthene skeleton having a sulfonate group.
6. The solid electrolytic capacitor as described in 5 above, wherein the self-doping type conductive polymer contains a crosslinked structure through a sulfone bond, represented by general formula (1):

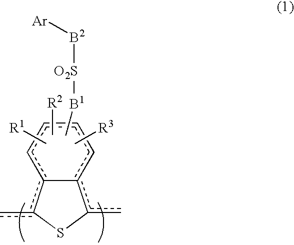

wherein R¹ to R³ independently represent a hydrogen atom, a linear or branched alkyl group having 1 to 20 carbon atoms, a linear or branched alkoxy group having 1 to 20 carbon atoms, a linear or branched alkenyl group having 2 to 20 carbon atoms, a linear or branched alkenyloxy group having 2 to 20 carbon atoms, a hydroxy group, a halogen atom, a nitro group, a cyano group, a trihalomethyl group, a phenyl group, a substituted phenyl group, or a —B¹—SO³⁻M⁺group; B¹ and B² independently represent —(CH₂)ₚ—(O)_{q}—(CH₂)ᵣ—; p and r independently represent 0 or an integer of 1 to 3; q represents 0 or 1; M⁺ represents a hydrogen ion, an alkali metal ion, or a quaternary ammonium ion; Ar represents a monovalent aromatic group, a substituted monovalent aromatic group, a monovalent heterocyclic group or a substituted monovalent heterocyclic group, which may contain polymer chains.
7. The solid electrolytic capacitor as described in 6 above, wherein the self-doping type conductive polymer contains a crosslinked structure through a sulfone bond, represented by general formula (2):

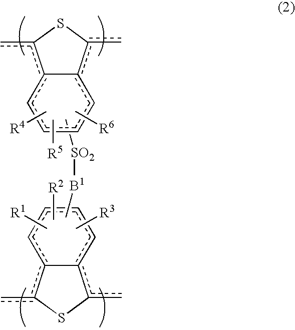

wherein R¹ to R⁶ independently represent a hydrogen atom, a linear or branched alkyl group having 1 to 20 carbon atoms, a linear or branched alkoxy group having 1 to 20 carbon atoms, a linear or branched alkenyl group having 2 to 20 carbon atoms, a linear or branched alkenyloxy group having 2 to 20 carbon atoms, a hydroxy group, a halogen atom, a nitro group, a cyano group, a trihalomethyl group, a phenyl group, a substituted phenyl group, or a —B¹—SO³⁻M⁺ group; B¹ and B² independently represent —(CH₂)ₚ—(O)_{q}—(CH₂)ᵣ—; p and r independently represent 0 or an integer of 1 to 3; q represents 0 or 1; M⁺ represents a hydrogen ion, an alkali metal ion, or a quaternary ammonium ion.
8. The solid electrolytic capacitor as described in 7 above, wherein the self-doping type conductive polymer contains a crosslinked structure through a sulfone bond, represented by general formula (3):

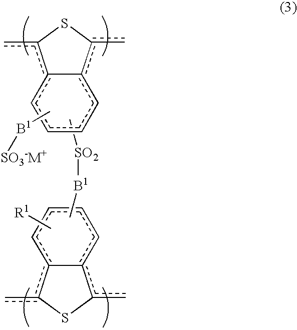

wherein B¹ represents —(CH₂)ₚ—(O)_{q}—(CH₂)ᵣ—; p and r independently represent 0 or an integer of 1 to 3; q represents 0 or 1; M⁺ represents a hydrogen ion, an alkali metal ion, or a quaternary ammonium ion).
9. The solid electrolytic capacitor as described in any one of 2 to 4 above, wherein the self-doping type conductive polymer contains a 5-membered heterocyclic skeleton having a sulfonate group.
10. The solid electrolytic capacitor as described in 9 above, wherein the self-doping type conductive polymer contains a crosslinked structure through a sulfone bond, represented by general formula (4):

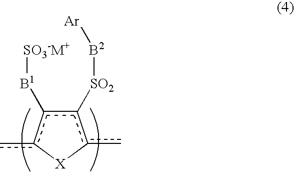

wherein X represents —S—, —O—, or —N(—R¹⁵)—; R¹⁵ represents a hydrogen atom, a linear or branched alkyl group having 1 to 20 carbon atoms, or a linear or branched alkenyl group having 2 to 20 carbon atoms; B¹ and B² independently represent —(CH₂)ₚ—(O)_{q}—(CH₂)ᵣ—; p and r independently represent 0 or an integer of 1 to 3; q represents 0 or 1; M⁺]represents a hydrogen ion, an alkali metal ion, or a quaternary ammonium ion); Ar represents a monovalent aromatic group, a substituted monovalent aromatic group, a monovalent heterocyclic group or a substituted monovalent heterocyclic group, which may contain polymer chains).
11. The solid electrolytic capacitor as described in 10 above, wherein the self-doping type conductive polymer contains a crosslinked structure through a sulfone bond, represented by general formula (5):

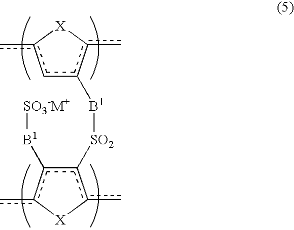

wherein X represents —S—, —O—, or —N(—R¹⁵)—; R¹⁵ represents a hydrogen atom, a linear or branched alkyl group having 1 to 20 carbon atoms, or a linear or branched alkenyl group having 2 to 20 carbon atoms; B¹ represents —(CH₂)ₚ—(O)_{q}—(CH₂)ᵣ—; p and r independently represent 0 or an integer of 1 to 3; q represents 0 or 1; M⁺ represents a hydrogen ion, an alkali metal ion, or a quaternary ammonium ion.
12. The solid electrolytic capacitor as described in 10 or 11 above, wherein the self-doping type conductive polymer contains a crosslinked structure through a sulfone bond, represented by general formula (6):

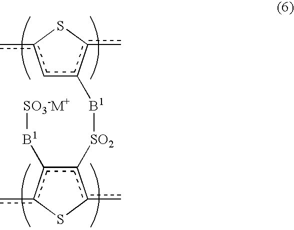

wherein B¹ represents —(CH₂)ₚ—(O)_{q}—(CH₂)ᵣ—; p and r independently represent 0 or an integer of 1 to 3; q represents 0 or 1; M⁺ represents a hydrogen ion, an alkali metal ion, or a quaternary ammonium ion.
13. The solid electrolytic capacitor as described in any one of 1 to 12 above, wherein the solid electrolyte layer comprises a first solid electrolyte layer formed on the dielectric layer that is formed on the valve-acting metal and containing the self-doping type conductive polymer having a crosslink between polymer chains, and a second solid electrolyte layer on the first solid electrolyte layer.
14. The solid electrolytic capacitor as described in 13 above; wherein the first solid electrolyte layer is water-insoluble.
15. The solid electrolytic capacitor as described in any one of 1 to 14 above, wherein the metal is a valve-acting metal having pores.
16. The solid electrolytic capacitor as described in 15 above, comprising an insulating material provided to ensure the insulation between an anode and a cathode, and a first solid electrolyte layer containing self-doping type conductive polymer having crosslink between polymer chains on at least a part of the dielectric film on the side of a cathode adjacent to the insulating material, and a second solid electrolyte layer on the first solid electrolyte layer.
17. The solid electrolytic capacitor as described in any one of 1 to 16 above, wherein the solid electrolyte layer containing the self-doping type conductive polymer having a crosslink between polymer chains has a film thickness within a range of 1 nm to 1,000 nm.
18. The solid electrolytic capacitor as described in any one of 1 to 17 above, wherein the solid electrolyte layer containing the self-doping type conductive polymer having a crosslink between polymer chains has an electric conductivity within a range of 0.001 to 100 S/cm.
19. The solid electrolytic capacitor as described in any one of 1 to 18 above, wherein the solid electrolyte layer containing the self-doping type conductive polymer having a crosslink between polymer chains has a pencil hardness of from HB to 4H.
20. A method of producing a solid electrolytic capacitor, the solid electrolytic capacitor being as described in any one of 1 to 19 above, comprising coating a film of a dielectric material with self-doping type conductive polymers each containing a chemical structure represented by general formula (7):

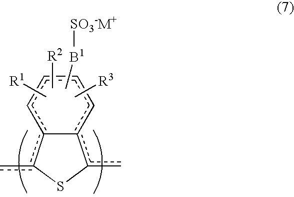

wherein R¹ to R³ independently represent a hydrogen atom, a linear or branched alkyl group having 1 to 20 carbon atoms, a linear or branched alkoxy group having 1 to 20 carbon atoms, a linear or branched alkenyl group having 2 to 20 carbon atoms, a linear or branched alkenyloxy group having 2 to 20 carbon atoms, a hydroxy group, a halogen atom, a nitro group, a cyano group, a trihalomethyl group, a phenyl group, a substituted phenyl group, or a —B¹—SO³⁻M⁺ group, provided that any one of R¹ to R³ is a hydrogen atom; B¹ represents —(CH₂)ₚ—(O)_{q}—(CH₂)ᵣ—; p and r independently represent 0 or an integer of 1 to 3; q represents 0 or 1; M⁺ represents a hydrogen ion, an alkali metal ion, or a quaternary ammonium ion), and dehydrocondensing the self-doping type conductive polymers to coat the film of the dielectric material with the self-doping type conductive polymer having a crosslink between the polymer chains, represented by general formula (1) as described in 6 above.
21. A method of producing a solid electrolytic capacitor as described in any one of 1 to 19 above, comprising coating a film of a dielectric material with self-doping type conductive polymers each containing a chemical structure represented by general formula (7) and/or general formula (8):

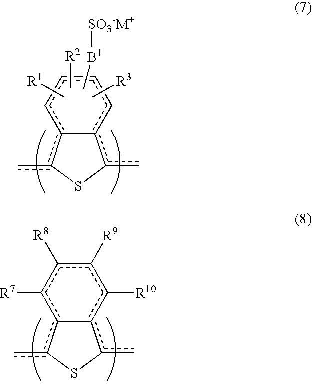

wherein R¹ to R³, B¹ and M⁺ in formula (7) have the same meanings as in general formula (7) described in 20 above, R⁷ to R¹⁰ in formula (8) independently represent a hydrogen atom, a linear or branched alkyl group having 1 to 20 carbon atoms, a linear or branched alkoxy group having 1 to 20 carbon atoms, a linear or branched alkenyl group having 2 to 20 carbon atoms, a linear or branched alkenyloxy group having 2 to 20 carbon atoms, a hydroxy group, a halogen atom, a nitro group, a cyano group, a trihalomethyl group, a phenyl group, a substituted phenyl group, or a —B¹—SO³⁻M³⁰ group, provided that, when dehydrocondensing the self-doping type conductive polymers containing the chemical structure represented by formulae (7) and (8), any one of R⁷ to R¹⁰ is a hydrogen atom and none of R¹ to R³ in formula (7) may be a hydrogen atom; when dehydrocondensing the self-doping type conductive polymers containing the chemical structure represented by formula (8), any one of R⁷ to R¹⁰ is a —B¹—SO³⁻M⁺ group, and at least one of R⁷ to R¹⁰ is a hydrogen atom; B¹ represents —(CH₂)ₚ—(O)_{q}—(CH₂)ᵣ—; p and r independently represent 0 or an integer of 1 to 3; q represents 0 or 1; M⁺ represents a hydrogen ion, an alkali metal ion, or a quaternary ammonium ion), and dehydrocondensing the self-doping type conductive polymers to coat the film of the dielectric material with the self-doping type conductive polymer having a crosslink between the polymer chains, represented by general formula (1) as described in 6 above.
22. A method of producing a solid electrolytic capacitor as described in any one of 1 to 19 above, comprising coating a film of a dielectric material with a self-doping type conductive polymer obtained by (co)polymerizing monomer(s) represented by general formula (9):

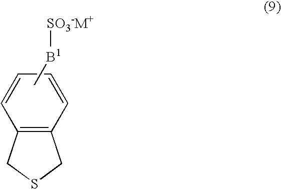

wherein B¹ represents —(CH₂)ₚ—(O)_{q}—(CH₂)ᵣ—; p and r independently represent 0 or an integer of 1 to 3; q represents 0 or 1; M⁺ represents a hydrogen ion, an alkali metal ion, or a quaternary ammonium ion), and dehydrocondensing the self-doping type conductive polymer to coat the film of the dielectric material with the self-doping type conductive polymer having a crosslink between the polymer chains, represented by general formula (3) as described in 8 above.
23. A method of producing a solid electrolytic capacitor, the solid electrolytic capacitor being as described in any one of 1 to 19 above, comprising coating a film of a dielectric material with self-doping type conductive polymers each containing a chemical structure represented by general formula (10):

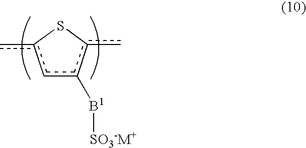

wherein B¹ represents —(CH₂)ₚ—(O)_{q}—(CH₂)ᵣ—; p and r independently represent 0 or an integer of 1 to 3; q represents 0 or 1; M⁺ represents a hydrogen ion, an alkali metal ion, or a quaternary ammonium ion), and dehydrocondensing the self-doping type conductive polymers to coat the film of the dielectric material with the self-doping type conductive polymers having a crosslink between the polymer chains, represented by general formula (6) as described in 12 above.
24. A method of producing a solid electrolytic capacitor, the solid electrolytic capacitor being as described in any one of 1 to 19 above, comprising coating a film of a dielectric material with a self-doping type conductive polymer obtained by (co)polymerizing monomer(s) represented by general formula (11):

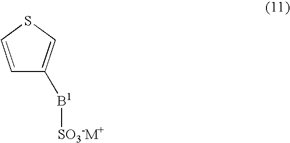

wherein M⁺ represents a hydrogen ion, an alkali metal ion, or a quaternary ammonium ion, and dehydrocondensing the self-doping type conductive polymer to coat the film of the dielectric material with the self-doping type conductive polymer having a crosslink between the polymer chains, represented by general formula (6) as described in 12 above.
25. A method of producing a solid electrolytic capacitor as described in any one of 1 to 19 above, comprising dipping a valve-acting metal having pores in a solution containing a self-doping type conductive polymer represented by general formula (7) and/or a self-doping type conductive polymer represented by general formula (8):

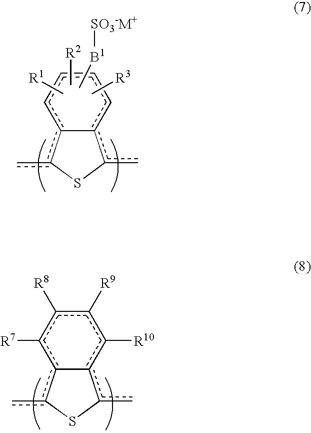

wherein R¹ to R³ and R⁷ to R¹⁰, B¹ and M⁺ in formulae (7) and (8) have the same meanings as in general formulae (7) and (8) described in 21 above, and heating the dipped valve-acting metal to dehydrocondense the self-doping type conductive polymer(s).
26. A method of producing a solid electrolytic capacitor as described in any one of 1 to 19 above, comprising coating a solution containing a self-doping type conductive polymer represented by general formula (7) and/or a self-doping type conductive polymer represented by general formula (8):

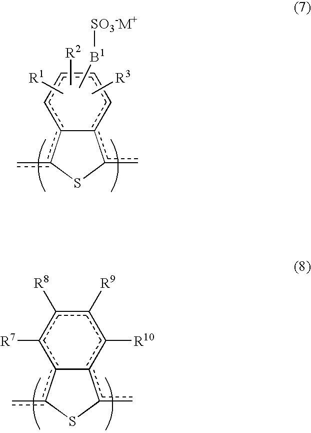

wherein R¹ to R³ and R⁷ to R¹⁰, B¹ and M⁺ in formulae (7) and (8) have the same meanings as in general formulae (7) and (8) described in 21 above, and heating the coated valve-acting metal to dehydrocondense the self-doping type conductive polymer(s).
27. A method of producing a solid electrolytic capacitor as described in any one of 1 to 19 above, comprising, in a capacitor comprising an insulating material to ensure the insulation between an anode and a cathode in a valve-acting metal having fine pores, coating at least a part of the dielectric film on the side of a cathode adjacent to the insulating material with a solution containing a self-doping type conductive polymer represented by general formula (7) and/or a self-doping type conductive polymer represented by general formula (8):

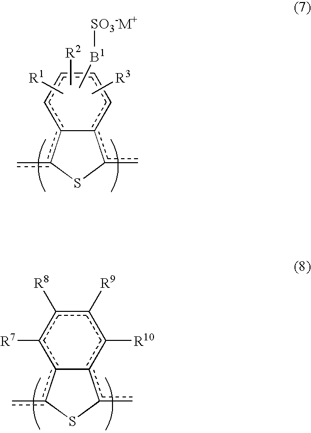

wherein R¹ to R³ and R⁷ to R¹⁰, B¹ and M⁺ in formulae (7) and (8) have the same meanings as in general formulae (7) and (8) described in 21 above, and heating the coated valve-acting metal to dehydrocondense the self-doping type conductive polymer(s).
28. A method of producing a solid electrolytic capacitor as described in any one of 1 to 19 above, comprising coating a valve-acting metal having pores with a solution containing a self-doping type conductive polymer obtained by (co)polymerizing a monomer represented by general formula (9):

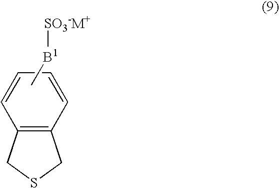

wherein B¹ and M⁺ have the same meanings as in general formula (9) described in 22 above), and heating the coated valve-acting metal to dehydrocondense the self-doping type conductive polymer(s).
29. A method of producing a solid electrolytic capacitor as described in any one of 1 to 19 above, comprising dipping a valve-acting metal having pores in a solution containing a self-doping type conductive polymer obtained by (co)polymerizing a monomer represented by general formula (9):

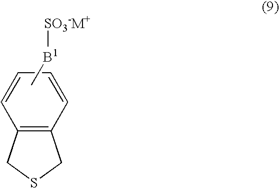

wherein B² and M⁺ have the same meanings as in general formula (9) described in 22 above, and heating the dipped valve-acting metal to dehydrocondense the self-doping type conductive polymer.
30. A method of producing a solid electrolytic capacitor as described in any one of 1 to 19 above, comprising, in a capacitor comprising an insulating material to ensure the insulation between an anode and a cathode in a valve-acting metal having fine pores, coating at least a part of the dielectric film on the side of a cathode adjacent to the insulating material with a solution containing a self-doping type conductive polymer obtained by (co)polymerizing a monomer represented by general formula (9):

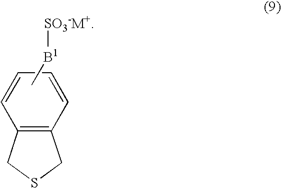

wherein B¹ and M⁺ have the same meanings as in general formula (9) described in 22 above, and heating the coated valve-acting metal to dehydrocondense the self-doping type conductive polymer.
31. The method of producing a solid electrolytic capacitor as described in any one of 20 to 22 and 25 to 30 above, wherein the dehydrocondensing reaction is performed by heating at a temperature within a range of 210° C. to 350° C.
32. The method of producing a solid electrolytic capacitor as described in 23 or 24 above, wherein the dehydrocondensing reaction is performed by heating at a temperature of 120 to 250° C. for 10 seconds to 60 minutes.
33. A method of producing a solid electrolytic capacitor as described in any one of 1 to 19 above, comprising the steps of: dipping a valve-acting metal having a dielectric material film layer in a solution containing a self-doping type conductive polymer which is capable of forming crosslink between the polymer chains, curing the self-doping type conductive polymer by dehydrocondensation reaction to cover the dielectric material film layer with a first solid electrolyte layer that is water-insoluble (step 1); dipping the resultant in a solution containing a monomer which forms a second solid electrolyte layer and then drying (step 2); and dipping the resultant in a solution containing an oxidizer and then drying (step 3) to provide a second solid electrolyte layer on the first solid electrolyte layer.
34. The method of producing a solid electrolytic capacitor as described in 33 above, comprising repeating a plurality of times a cycle consisting of the steps of: dipping a valve-acting metal having a dielectric material film layer in a solution containing a self-doping type conductive polymer which is capable of forming crosslink between the polymer chains, curing the self-doping type conductive polymer by dehydrocondensation reaction to cover the dielectric material film layer with a first solid electrolyte layer that is water-insoluble (step 1); dipping the resultant in a solution containing a monomer which forms a second solid electrolyte layer and then drying (step 2); and dipping the resultant in a solution containing an oxidizer and then drying (step 3) respectively to provide second solid electrolyte layers on the first solid electrolyte layers.
35. The method of producing a solid electrolytic capacitor, as described in 33 above, comprising repeating a plurality of times a cycle consisting of the steps of: coating a valve-acting metal having a dielectric material film layer with a solution containing a self-doping type conductive polymer which is capable of forming crosslink between the polymer chains, curing the self-doping type conductive polymer by dehydrocondensation reaction to cover the dielectric material film layer with a first solid electrolyte layer that is water-insoluble (step 1); dipping the resultant in a solution containing a monomer which forms a second solid electrolyte layer and then drying (step 2); and dipping the resultant in a solution containing an oxidizer and then drying (step 3) respectively to provide second solid electrolyte layers on the first solid electrolyte layers.
36. The method of producing a solid electrolytic capacitor as described in any one of 33 to 35 above, wherein the oxidizer is a persulfate.
37. The method of producing a solid electrolytic capacitor as described in any one of 33 to 36 above, wherein the solution containing the oxidizer is a suspension that contains organic fine particles.
38. The method producing a solid electrolytic capacitor as described in 37 above, wherein the organic fine particles have an average particle diameter (D₅₀) within a range of 1 to 20 μm.
39. The method of producing a solid electrolytic capacitor as described in 38 above, wherein the organic particles are particles of at least one compound selected from the group consisting of aliphatic sulfonic acid compounds, aromatic sulfonic acid compounds, aliphatic carboxylic acid compounds, aromatic carboxylic acid compounds, salts thereof, and peptide compounds.
40. A solid electrolytic capacitor produced by the production method as described in any one of 20 to 39 above.

The present invention enables to stably produce thin solid electrolytic capacitor elements suitable for laminated type solid electrolytic capacitors, showing less short-circuit failure and less fluctuation in the shape of element, which allows to increase the number of laminated capacitor elements in a solid electrolytic capacitor chip to make a capacitor having a high capacity, and having less fluctuation in equivalent series resistance.

### BRIEF EXPLANATION OF DRAWINGS

FIG. 1 is a cross-sectional view showing an example of a solid electrolytic capacitor produced using a capacitor element; and

FIG. 2 is a cross-sectional view showing an example of a solid electrolytic capacitor produced by laminating capacitor elements.

FIG. 3 is a spectrum showing the S2p binding energy measured by X-ray photoelectron spectroscopy (XPS), wherein phenylsulfone, 2,2′,5′,2″-terthiophene and sodium p-toluenesulfonic acid are indicated in a solid line, dashed-dotted line and dotted line respectively.

FIG. 4 is a spectrum showing the S2p binding energy measured by X-ray photoelectron spectroscopy (XPS), in the case where the self-doping type conductive polymer of the present invention is applied on a dielectric layer on the surface of a chemically formed aluminum foil and dried (dash line in the figure) and the case where the coated self-doping type conductive polymer is further subjected to crosslinking treatment according to the present invention (solid line).

FIG. 5(A) is an oblique perspective figure showing a thin rectangular capacitor element, wherein a first solid electrolyte layer (4a) comprising a self-doping type conductive polymer is provided along with a masking layer (3) formed on a dielectric film (2) on the side of a cathode, and further a second electrolyte layer (4b) is provided on the first solid electrolyte layer. FIG. 5(B) is a cross-sectional view of the rectangular element of (A) which is cut off in a longitudinal direction.

FIG. 6 is a schematic view showing an example of the coating range of the conductive polymer (12) having crosslinks between polymer chains partially on a cathode-formed portion (13) in a chemically-formed aluminum foil which portion is insulated from an anode-formed portion (10) by an insulating material (masking) (11).

FIG. 7 is a schematic view showing an example of the coating range of the conductive polymer (12) having crosslinks between polymer chains with which a cathode-formed portion (13) in a chemically-formed aluminum foil is impregnated entirely, which portion is insulated from an anode-formed (10) by an insulating material (masking) (11).

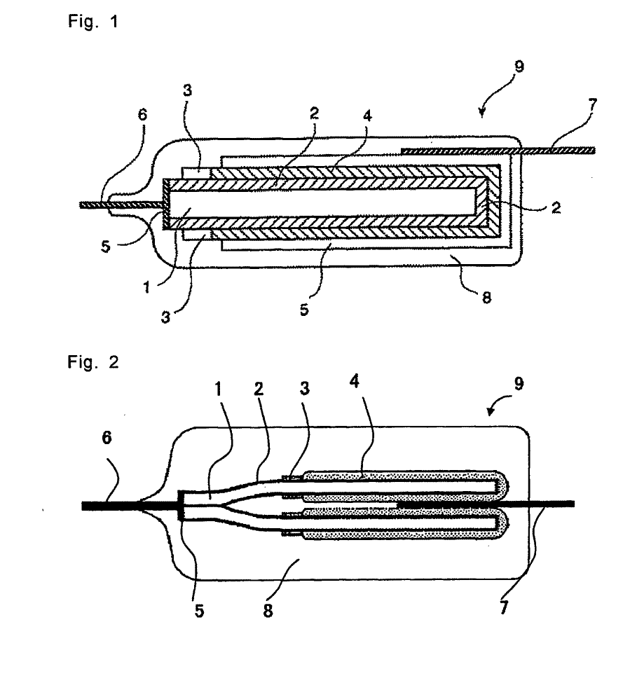

### EXPLANATION OF SYMBOLS

1 Anode substrate
2 Dielectric material (oxide film) layer
3 Masking
4 Semiconductor (solid electrolyte) layer
5 Conductor layer
6,7 Lead wire
8 Sealing resin
9 Solid electrolytic capacitor
10 Anode formed part
11 Insulating material
12 Coated area
13 Cathode formed part

### BEST MODE FOR CARRYING OUT THE INVENTION

Hereinafter, the present invention will be explained with reference to the attached drawings.

The solid electrolytic capacitor that is used in the present invention includes an anode substrate (hereinafter, also referred to as “substrate”) made of metal that has a dielectric material film on a surface thereof. The dielectric material film (2) on the surface of the substrate (1) is usually formed by a chemical forming treatment of a porous molded article of a valve-acting metal.

The valve-acting metals that can be used in the present invention include metals such as aluminum, tantalum, niobium, titanium, zirconium, magnesium and silicon or alloys thereof. The porous form may be any of porous molded products such as etched rolled foil and sintered fine powder.

Specific examples of the anode substrate that can be used include porous sintered bodies, plates (inclusive of ribbons, foils and so on) that are surface-treated by etching or the like and wires made of these metals. Anode substrates in the form of plates or foils are preferred. Further, known methods can be used to form the dielectric material film on the surface of the metallic porous material. For example, in the case of using an aluminum foil, the aluminum foil can be anodized in an aqueous solution containing boric acid, phosphoric acid, or adipic acid, or sodium salt or ammonium salt thereof or the like to form an oxidized film. On the other hand, in the case of using a sintered body of tantalum powder, it is anodized in an aqueous phosphoric acid solution to form an oxidized film on the sintered body.

The thickness of the valve-acting metal foil may vary depending on the purpose for which it is used. For example, a foil having a thickness of about 40 μm to about 300 μm can be used. To form a thin solid electrolytic capacitor in the case of, for example, an aluminum foil, it is preferable that a foil having a thickness of 80 μm to 250 μm is used and the maximum height of the element provided with the solid electrolytic capacitor is set to 250 μm or less. Although the size and shape of the metal foil may also vary depending on the intended use, the metal foil preferably has a rectangular form having a width of about 1 mm to about 50 mm and a length of about 1 mm to about 50 mm, more preferably a width of about 2 mm to about 15 mm and a length of about 2 mm to about 25 mm as a unit of a plate-form element.

Chemical forming conditions such as a chemical forming solution and chemical forming voltage to be used for chemical forming are confirmed by preliminary experiments and set to appropriate values depending on the capacity, voltage resistance and so on required for solid electrolytic capacitor to be produced. Note that upon the chemical forming treatment, generally a masking (3) is provided in order to prevent the forming solution from penetrating into a portion which will serve as an anode of the solid electrolytic capacitor and ensure that the portion is insulated from a solid electrolyte (4) (cathode part) that is formed in a subsequent step.

Insulating materials to ensure insulation/separation between an anode and a cathode are used as a masking material. For example, generally used heat resistant resins, preferably heat resistant resins that is soluble or swellable in solvents or precursors thereof, compositions composed of inorganic fine powder and cellulose-based resins can be used. However, the material of the masking material is not particularly limited. Specific examples thereof include polyphenylsulfone (PPS), polyether sulfone (PES), cyanate ester resins, fluorocarbon resins (polytetrafluoroethylene, tetrafluoroethylene/perfluoroalkyl vinyl ether copolymer and so on), low molecular weight polyimide, and derivatives thereof and precursors thereof. In particular, low molecular weight polyimide, polyether sulfone, fluorocarbon resins and precursors thereof are preferable.

Hereinafter, the method of the present invention for producing a solid electrolytic capacitor comprising a self-doping type conductive polymer layer having crosslinks between polymer chains on the dielectric material film formed on the surface of the valve-acting metal having pores will be explained in order.

The solid electrolytic capacitor of the present invention is a solid electrolytic capacitor that is featured by having a layer of a self-doping type conductive polymer layer having a crosslink between polymer chains on a dielectric material film formed on a metal surface, and preferably includes a first solid electrolyte layer containing the self-doping type conductive polymer and a second solid electrolyte layer on the first solid electrolyte layer. The self-doping type conductive polymer having a crosslink between polymer chains thereof that constitutes the first solid electrolyte layer is preferably water-insoluble.

Hereinafter, the self-doping type conductive polymer having a crosslink between polymer chains thereof that constitutes the first solid electrolyte layer is explained.

The self-doping type conductive polymer having a crosslink between polymer chains thereof contains a sulfonate group, forms a crosslink through a sulfone bond and contains a crosslinked structure through a sulfone bond in an amount of preferably 0.01 mol % to 90 mol %, more preferably 1 mol % to 90 mol % based on the repeating units of the polymer.

It has been believed that the method of imparting the self-doping type conductive polymer with solvent resistance, particularly water resistance that can be used is to heat a self-doping type conductive polymer of a water-soluble polyaniline type at about 200° C. for about 15 minutes, and this results in releasing a part of the carboxylate groups and sulfonate groups of the conductive polymer to increase water resistance.

However, it has been also known that the heat treatment at high temperatures leads to decomposition of the material itself, so that volume conductivity value, which is essential, is significantly decreased.

The inventors of the present invention have found that partial crosslinking of such a water-soluble self-doping type conductive polymer increases solvent resistance without a great decrease in conductivity.

Although any crosslinking method may be used, it is preferable that crosslinking is effected after a solution of the polymer is coated since polymerization using a crosslinkable monomer results in a decrease in solubility of the resultant polymer in solvents such as water, which solubility in solvents is essential.

In the case of the self-doping type conductive polymer containing a water-soluble isothianaphthene skeleton, heating at 300° C. for a short time (within 5 minutes) leads to generation of a crosslinked structure by condensation of a portion of sulfonate groups with a benzene ring of another isothianaphthene molecule, so that the water resistance of the resultant polymer increases without a decrease in electrical properties.

As mentioned above, crosslink of the polymer chains of the self-doping type conductive polymer containing isonaphthene skeleton renders the polymer excellent in not only water resistance but also solvent resistance. Basically, any crosslinking method can be used. However, the self-doping type conductive polymer of polyisothianaphthene type containing a crosslinked structure through sulfone bonds is excellent in not only heat resistance and water resistance but also solvent resistance.

More particularly, the self-doping type conductive polymer having crosslinks between polymer chains according to a preferred embodiment of the present invention has a Bronsted acid group in at least one structural unit among the repeating units of a n-electron conjugate polymer. More specifically, although its chemical structure is not particularly limited, the cross-linked self-doping type conductive polymer may contain a chemical structure having crosslinks through sulfone bonds, preferably represented by general formula (1) below.

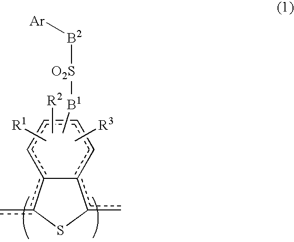

In general formula (1) above, R¹ to R³ independently represent a hydrogen atom, a linear or branched alkyl group having 1 to 20 carbon atoms, a linear or branched alkoxy group having 1 to 20 carbon atoms, a linear or branched alkenyl group having 2 to 20 carbon atoms, a linear or branched alkenyloxy group having 2 to 20 carbon atoms, a hydroxy group, a halogen atom, a nitro group, a cyano group, a trihalomethyl group, a phenyl group, a substituted phenyl group, or a —B¹—SO³⁻M⁺ group; B¹ and B² independently represent —(CH₂)ₚ—(O)_{q}—(CH₂)ᵣ—; p and r independently represent 0 or an integer of 1 to 3; q represents 0 or 1; M⁺ represents a hydrogen ion, an alkali metal ion, or a quaternary ammonium ion.

Further, the self-doping type conductive polymer having crosslinks between polymer chains of the present invention includes a self-doping type conductive polymer having crosslinks between polymer chains, wherein crosslinks are formed between a monovalent aromatic group, a substituted monovalent aromatic group, a monovalent heterocyclic group or a substituted monovalent heterocyclic group, which groups may contain polymer chains. That is, Ar in general formula (1) represents a monovalent aromatic group, a substituted monovalent aromatic group, a monovalent heterocyclic group or a substituted monovalent heterocyclic group which may contain polymer chains. More specifically, preferred examples of such a monovalent aromatic group or a monovalent heterocyclic group which may contain polymer chains include a phenyl group, a substituted phenyl group, a naphthyl group, a substituted naphthyl group, anthranyl group, a substituted anthranyl group, a quinolyl group, a substituted quinolyl group, a quinoxalyl group, a substituted quinoxalyl group, a thienyl group, a substituted thienyl group, a pyrrolyl group, a substituted pyrrolyl group, a furanyl group, a substituted furanyl group, an isothianaphthenylene group, a substituted isothianaphthenyl group, a carbazolyl group, and a substituted carbazolyl group. Particularly preferred examples thereof include a phenyl group, a substituted phenyl group, a naphthyl group, a substituted naphthyl group, a quinoxalyl group, a substituted quinoxalyl group, a thienyl group, a substituted thienyl group, a pyrrolyl group, a substituted pyrrolyl group, an isothianaphthenylene group, and a substituted isothianaphthenylene group.

Further, preferably, the self-doping type conductive polymer containing a chemical structure having crosslinks through sulfone bonds may be one containing a chemical structure having crosslinks through sulfone bonds represented by general formula (2) below.

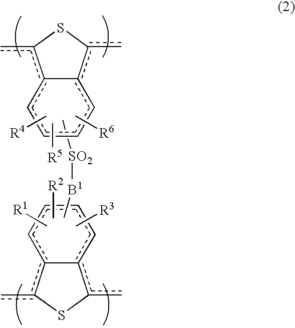

In general formula (2), R¹ to R⁶ independently represent a hydrogen atom, a linear or branched alkyl group having 1 to 20 carbon atoms, a linear or branched alkoxy group having 1 to 20 carbon atoms, a linear or branched alkenyl group having 2 to 20 carbon atoms, a linear or branched alkenyloxy group having 2 to 20 carbon atoms, a hydroxy group, a halogen atom, a nitro group, a cyano group, a trihalomethyl group, a phenyl group, a substituted phenyl group, or a —B¹—SO³⁻M⁺ group; B¹ represents —(CH₂)ₚ—(O)_{q}—(CH₂)ᵣ—; p and r independently represent 0 or an integer of 1 to 3; q represents 0 or 1; M⁺ represents a hydrogen ion, an alkali metal ion, or a quaternary ammonium ion.

The crosslinked structure represented by general formula (2) can be produced by dehydrocondensing self-doping type conductive polymers each having a structure represented by general formula (7) and/or a structure represented by general formula (8) below with each other between molecules (provided that when none of R⁷ to R¹⁰ is a —B¹—SO³⁻M⁺ group, at least one of the polymers has a chemical structure containing a —B¹—SO³⁻M⁺ group represented by general formula (7)) and a benzene ring of the other polymer which is to be dehydrocondensed with the —B¹—SO³⁻M⁺ group is substituted with at least one hydrogen atom.

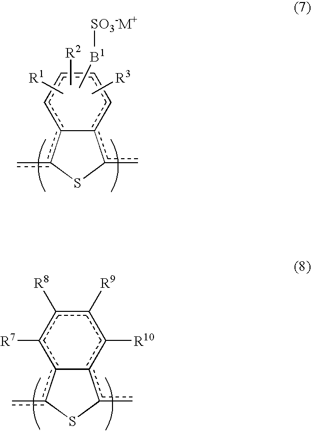

In general formulae (7) and (8), R¹ to R³ and R⁷ to R¹⁰ independently represent a hydrogen atom, a linear or branched alkyl group having 1 to 20 carbon atoms, a linear or branched alkoxy group having 1 to 20 carbon atoms, a linear or branched alkenyl group having 2 to 20 carbon atoms, a linear or branched alkenyloxy group having 2 to 20 carbon atoms, a hydroxy group, a halogen atom, a nitro group, a cyano group, a trihalomethyl group, a phenyl group, a substituted phenyl group, or a —B¹—SO³⁻M⁺ group, provided that when dehydrocondensing the self-doping type conductive polymer containing a chemical structure represented by formula (7) or (8) between molecules, any one of R⁷ to R¹⁰ is a hydrogen atom and each of R¹ to R³ may be a group other than a hydrogen atom. When dehydrocondensing the self-doping type conductive polymer containing a chemical structure represented by (8) between molecules, at least one of R⁷ to R¹⁰ is a —B¹—SO³⁻M⁺ group and at least one of them is a hydrogen atom; B¹ represents —(CH₂)ₚ—(O)_{q}—(CH₂)ᵣ—; p and r independently represent 0 or an integer of 1 to 3; q represents 0 or 1; M⁺ represents a hydrogen ion, an alkali metal ion, or a quaternary ammonium ion.

Here, preferred examples of R¹ to R¹⁰ above include a hydrogen atom, an alkyl group, an alkoxy group, an alkenyl group, an alkenyloxy group, a phenyl group, and a substituted phenyl group, and a sulfonate group. Specific examples of the alkyl group include methyl, ethyl, propyl, isopropyl, butyl, pentyl, hexyl, heptyl, octyl, nonyl, decyl, undecyl, dodecyl, tetradecyl, hexadecyl, ethoxyethyl, methoxyethyl, methoxyethoxyethyl, acetonyl, and phenacyl groups. Specific examples of the alkenyl group include allyl and 1-butenyl groups. Specific examples of the alkoxy group include methoxy, ethoxy, propoxy, isopropoxy, butoxy, pentyloxy, hexyloxy, octyloxy, and dodecyloxy groups. Specific examples of the alkenyloxy group include allyoxy and 1-butenyloxy. Specific examples of the substituted phenyl group include a fluorophenyl group, a chlorophenyl group, a bromophenyl group, a methylphenyl group, and a methoxyphenyl group.

In the chain of the alkyl group, alkoxy group, alkenyl group or alkenyloxy group may contain a carbonyl bond, an ether bond, an ester bond, a sulfonate ester bond, an amide bond, a sulfonamide bond, a sulfide bond, a sulfinyl bond, a sulfonyl bond, or an imino bond. Among these, for example, specific examples of the alkyl ester group include alkoxycarbonyl groups such as methoxycarbonyl, ethoxycarbonyl and butoxycarbonyl, acyloxy groups such as acetoxy and butyroyloxy, methoxyethoxy, and methoxyethoxyethoxy.

M⁺ represents a hydrogen ion, alkali metal ion such as Na³⁰, Li⁺ or K⁺, or a cation of a quaternary ammonium represented by N(R11) (R¹²) (R¹³) (R¹⁴)⁺, and M⁺ may be a mixture that contains at least one of the above-mentioned cations.

R¹¹ to R¹⁴ independently represent a hydrogen atom, a linear or branched, substituted or non-substituted alkyl group each having 1 to 30 carbon atoms, or a substituted or non-substituted aryl group. R¹¹ to ^{R}¹⁴ may be an alkyl group or an aryl group that contains a group containing an element other than carbon and hydrogen, such as an alkoxy group, a hydroxyl group, an oxyalkylene group, a thioalkylene group, an azo group, an azobenzene group, or a p-diphenyleneoxy group.

Examples of the cations of the quaternary ammonium include NH₄⁺, NH(CH₃)₃⁺, NH(C₆H₅)₃⁺, and N(CH₃)₂(CH₂OH)(CH₂—Z)³⁰ (where Z represents any substituent having a chemical formula weight of 600 or less, for example, a substituent such as a phenoxy group, a p-diphenyleneoxy group, a p-alkoxydiphenyleneoxy group, or a p-alkoxyphenylazophenoxy group). To convert the cation into a specified cation, an ion exchange resin usually used may be employed.

B¹ or B² in general formulae (1) to (11) represents —(CH₂)ₚ—(O)_{q}—(CH₂)ᵣ—; p and r independently represent 0 or an integer of 1 to 3; q represents 0 or 1, when p=q=r=0, B (B¹ or B²) represents a simple chemical bond, and the —B¹—SO₃—M⁺ as —SO₃—M⁺ is directly connected to a target binding site through the sulfur atom.

Preferable examples of B¹ or B² in general formulae (1) to (11) include a simple chemical bond, methylene, ethylene, propylene, trimethylene, butylene, tetramethylene, pentylene, hpentamethylene, hexylene, hexaethylene, arylene, butadienylene, oxymethylene, oxyethylene, oxypropylene, methyleneoxyethylene, and ethyleneoxyethylene.

In the —(CH₂)ₚ—(O)_{q}—(CH₂)ᵣ— represented by B¹ or B², examples of such preferable B¹ or B² include a simple chemical bond, ethylene, trimethylene, oxyethylene, and ethyleneoxyethylene. Among the components that constitute the self-doping type conductive polymer in preferred embodiments of the present invention, the crosslinked structure portion represented by general formula (1) is preferably contained in an amount of 1 to 90 mol %, more preferably 20 to 80 mol % based on the repeating units of the polymer. When the crosslinked structure portion is contained in an amount of less than 1 mol %, the polymer tends to have a reduced water resistance. On the other hand, when the crosslinked structure portion is contained in an amount of more than 90 mol %, the polymer tends to have a reduced conductivity.

The self-doping type conductive polymer according to the present invention may have, for example, a polyaniline structure, a polypyrrole structure, a polythiophene structure, or a polycarbazole structure.

Among the components that constitute the self-doping type conductive polymer in preferred embodiments of the present invention, the portion other than the crosslinked structure portion represented by general formula (1) is not particularly limited as far as the conductivity of the polymer is not deteriorated. However, it is preferable that that portion contains an isothianaphthene skeleton, that is, it is preferable that the self-doping type conductive polymer is a (co)polymer of a constituent having the chemical structure represented by general formula (7) and/or a constituent having the chemical structure represented by general formula (8). Further, the self-bonding type conductive polymer is a self-doping type conductive polymer that partially includes the chemical structure represented by general formula (7):

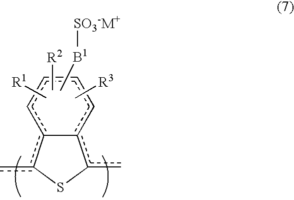

wherein R¹ to R³, B¹ and M⁺ have the same meanings as described above. In this case, to cause the polymer to be crosslinked through sulfone bonds by dehydrocondensing with sulfonate groups, it is necessary that at least one of R¹ to R³ represents a hydrogen atom.

Further, a preferred structure of the self-doping type conductive polymer, which can be a precursor of the self-doping type conductive polymer having crosslinks between polymer chains of the present invention, is one that is obtained by (co)polymerizing monomers represented by general formula (9):

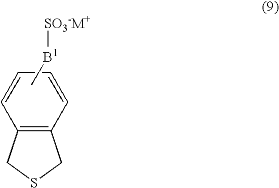

wherein B¹ represents —(CH₂)ₚ—(O)_{q}—(CH₂)ᵣ—; p and r independently represent 0 or an integer of 1 to 3; q represents 0 or 1; M⁺ represents a hydrogen ion, an alkali metal ion, or a quaternary ammonium ion. The (co)polymer crosslinked by dehydrocondensation is the polymer that is crosslinked by the crosslinked structure through sulfone bonds represented by general formula (3):

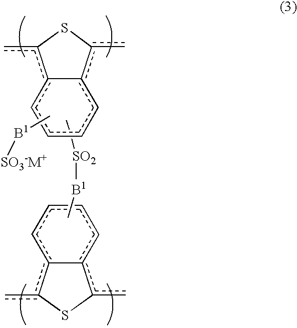

wherein B¹ represents —(CH₂)ₚ—(O)_{q}—(CH₂)ᵣ—; p and r independently represent 0 or an integer of 1 to 3; q represents 0 or 1; M³⁰ represents a hydrogen ion, an alkali metal ion, or a quaternary ammonium ion. Further, the structure wherein the structure B¹ is absent and a sulfur atom is directly attached to the benzene ring is preferred.

In the present invention, the self-doping type conductive polymer having an isothianaphthene skeleton represented by general formula (7) and/or an isothianaphthene skeleton represented by general formula (8) is a water-soluble conductive polymer to which a sulfonate group is covalently bonded directly or through a side chain of the polymer.

Specific examples of the polymer containing the isothianaphthene structure include poly(isothianaphthenesulfonic acid) or various salt structures thereof and substituted derivatives thereof, (co)polymers containing a repeating unit such as poly(isothianaphthenesulfonic acid-co-isothianaphthene) or various salt structures thereof and substituted derivatives thereof.

More specifically, it is preferable that the crosslinked self-doping type conductive polymer having crosslinks between polymer chains of the present invention contains a structure crosslinked through sulfone bond, represented by general formula (4).

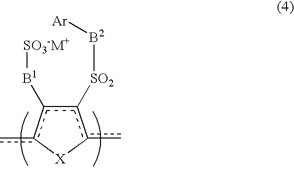

In general formula (4), X represents —S—, —O—, or —N(—R¹⁵)—; R¹⁵ represents a hydrogen atom, a linear or branched alkyl group having 1 to 20 carbon atoms, or a linear or branched alkenyl group having 2 to 20 carbon atoms; B¹ and B² independently represent —(CH₂)ₚ—(O)_{q}—(CH₂(ᵣ—; p and r independently represent 0 or an integer of 1 to 3; q represents 0 or 1; M⁺ represents a hydrogen ion, an alkali metal ion, or a quaternary ammonium ion.

Further, the self-doping type conductive polymer having crosslinks between polymer chains of the present invention includes a self-doping type conductive polymer having crosslinks between polymer chains, wherein crosslinks are formed between a monovalent aromatic group, a substituted monovalent aromatic group, a monovalent heterocyclic group or a substituted monovalent heterocyclic group, which groups may contain polymer chains. That is, Ar in general formula (4) represents a monovalent aromatic substituent, a substituted monovalent aromatic group, a monovalent heterocyclic group or a monovalent heterocyclic group. More specifically, preferred examples thereof include a phenyl group, a substituted phenyl group, a naphthyl group, a substituted naphthyl group, an anthranyl group, a substituted anthranyl group, a quinolyl group, a substituted quinolyl group, a quinoxalyl group, a substituted quinoxalyl group, a thienyl group, a substituted thienyl group, a pyrrolyl group, a substituted pyrrolyl group, a furanyl group, a substituted furanyl group, an isothianaphthenylene group, a substituted isothianaphthenylene group, a carbazolyl group, and a substituted carbazolyl group. Particularly preferred examples thereof include a phenyl group, a substituted phenyl group, a naphthyl group, a substituted naphthyl group, a quinoxalyl group, a substituted quinoxalyl group, a thienyl group, a substituted thienyl group, a pyrrolyl group, a substituted pyrrolyl group, an isothianaphthenylene group, and a substituted isothianaphthenylene group.

Further, preferably, the self-doping type conductive polymer that is crosslinked by the crosslinked structure through sulfone bonds represented by general formula (4) may be one containing a structure that can form a crosslink through sulfone bonds represented by general formula (5) below.

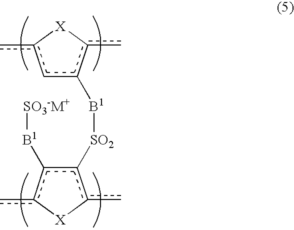

In general formula (5), X represents —S—, —O—, or —N(—R¹⁵)—; R¹⁵ represents a hydrogen atom, a linear or branched alkyl group having 1 to 20 carbon atoms, or a linear or branched alkenyl group having 2 to 20 carbon atoms; B represents —(CH₂)ₚ—(O)_{q}—(CH₂)ᵣ—; p and r independently represent 0 or an integer of 1 to 3; q represents 0 or 1; M⁺ represents a hydrogen ion, an alkali metal ion, or a quaternary ammonium ion.

Here, specific examples of the alkyl group represented by R¹⁵ include methyl, ethyl, propyl, isopropyl, butyl, pentyl, hexyl, heptyl, octyl, nonyl, decyl, undecyl, dodecyl, tetradecyl, hexadecyl, ethoxyethyl, methoxyethyl, methoxyethoxyethyl, acetonyl, and phenacyl groups. Specific examples of the alkenyl include allyl and 1-butenyl groups.

The crosslinked structure represented by general formula (6) can be produced by dehydrocondensing the self-doping type conductive polymer having the chemical structure represented by general formula (10) between molecules:

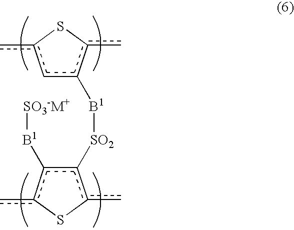

wherein B¹ represents —(CH₂)ₚ—(O)_{q}—(CH₂)ᵣ—; p and r independently represent 0 or an integer of 1 to 3; q represents 0 or 1; and M⁺ represents a hydrogen ion, an alkali metal ion or a quaternary ammonium ion,

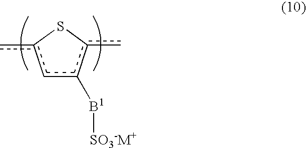

wherein B¹ represents —(CH₂)ₚ—(O)_{q}—(CH₂)ᵣ—; p and r independently represent 0 or an integer of 1 to 3; q represents 0 or 1; and M⁺ represents a hydrogen ion, an alkali metal ion or a quaternary ammonium ion.

Further, the crosslinked structure represented by general formula (6) can be produced by dehydrocondensing a self-doping type conductive polymer obtained by (co)polymerizing the monomer having the structure represented by general formula (11) between molecules:

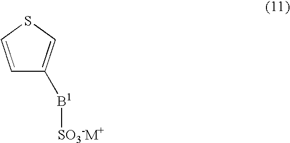

wherein B¹ represents —(CH₂)ₚ—(O)_{q}—(CH₂)ᵣ—; p and r independently represent 0 or an integer of 1 to 3; q represents 0 or 1; and M⁺ represents a hydrogen ion, an alkali metal ion or a quaternary ammonium ion.

The repeating unit of a chemical structure containing a sulfonate group in the above-mentioned (co)polymer usually is present in an amount of within a range of 100 mol % to 50 mol %, preferably 100 mol % to 80 mol % based on the total repeating units. The (co)polymer may be a (co)polymer that contains a repeating unit consisting of other π-conjugate chemical structure(s), and may be a (co)polymer consisting of, for example, 2 to 5 repeating units.

Note that “(co)polymer containing repeating unit” as used herein is not necessarily limited to a (co)polymer that contains the repeating unit continuously, but includes a (co)polymer that contains the repeating unit irregularly and/or discontinuously in the π-conjugate main chain as in random copolymer as far as desired conductivity is exhibited based on the n-conjugate main chain.

Specific examples of preferred chemical structure represented by general formula (7) include 5-sulfoisothianaphthene-1,3-diyl, 4-sulfoisothianaphthene-1,3-diyl, 4-methyl-5-sulfoisothianaphthene-1,3-diyl, 6-methyl-5-sulfoisothianaphthene-1,3-diyl, 6-methyl-4-sulfoisothianaphthene-1,3-diyl, 5-methyl-4-sulfoisothianaphthene-1,3-diyl, 6-ethyl-5-sulfoisothianaphthene-1,3-diyl, 6-propyl-5-sulfoisothianaphthene-1,3-diyl, 6-butyl-5-sulfoisothianaphthene-1,3-diyl, 6-hexyl-5-sulfoisothianaphthene-1,3-diyl, 6-decyl-5-sulfoisothianaphthene-1,3-diyl, 6-methoxy-5-sulfoisothianaphthene-1,3-diyl, 6-ethoxy-5-sulfoisothianaphthene-1,3-diyl, 6-chloro-5-sulfoisothianaphthene-1,3-diyl, 6-bromo-5-sulfoisothianaphthene-1,3-diyl, 6-trifluoromethyl-5-sulfoisothianaphthene-1,3-diyl, 5-(sulfomethane)-isothianaphthene-1,3-diyl, 5-(2′-sulfoethane)-isothianaphthene-1,3-diyl, 5-(2′-sulfoethoxy)-isothianaphthene-1,3-diyl, 5-(2′-(2″-sulfoethoxy)methane)-isothianaphthene-1,3-diyl and 5-(2′-(2″-sulfoethoxy)ethane)-isothianaphthene-1,3-diyl, and lithium salts, sodium salts, ammonium salts, methylammonium salts, ethylammonium salts, dimethylammonium salts, diethylammonium salts, trimethylammonium salts, triethylammonium salts, tetramethylammonium salts, and tetraethylammonium salts thereof.

Specific examples of the preferred chemical structure represented by general formula (8) include 5-sulfoisothianaphthene-1,3-diyl, 4-sulfoisothianaphthene-1,3-diyl, 4-methyl-5-sulfoisothianaphthene-1,3-diyl, 6-methyl-5-sulfoisothianaphthene-1,3-diyl, 6-methyl-4-sulfoisothianaphthene-1,3-diyl, 5-methyl-4-sulfoisothianaphthene-1,3-diyl, 6-ethyl-5-sulfoisothianaphthene-1,3-diyl, 6-propyl-5-sulfoisothianaphthene-1,3-diyl, 6-butyl-5-sulfoisothianaphthene-1,3-diyl, 6-hexyl-5-sulfoisothianaphthene-1,3-diyl, 6-decyl-5-sulfoisothianaphthene-1,3-diyl, 6-methoxy-5-sulfoisothianaphthene-1,3-diyl, 6-ethoxy-5-sulfoisothianaphthene-1,3-diyl, 6-chloro-5-sulfoisothianaphthene-1,3-diyl, 6-bromo-5-sulfoisothianaphthene-1,3-diyl, 6-trifluoromethyl-5-sulfoisothianaphthene-1,3-diyl, 5-(sulfomethane)-isothianaphthene-1,3-diyl, 5-(2′-sulfoethane)-isothianaphthene-1,3-diyl, 5-(2′-sulfoethoxy)-isothianaphthene-1,3-diyl, 5-(2′-sulfoethane)-isothianaphthene-1,3-diyl, 5-(2′-(2″-sulfoethoxy)methane)-isothianaphthene-1,3-diyl, and 5-(2′-(2″-sulfoethoxy)ethane)-isothianaphthene-1,3-diyl, and lithium salts, sodium salts, ammonium salts, methylammonium salts, ethylammonium salts, dimethylammonium salts, diethylammonium salts, trimethylammonium salts, triethylammonium salts, tetramethylammonium salts, and tetraethylammonium salts thereof; or isothianaphthene-1,3-diyl, 4-methyl-isothianaphthene-1,3-diyl, 5-methyl-isothianaphthene-1,3-diyl, 4,5-dimethyl-isothianaphthene-1,3-diyl, 5,6-dimethyl-isothianaphthene-1,3-diyl, 4,5-dimethoxy-isothianaphthene-1,3-diyl, 5,6-dimethoxy-isothianaphthene-1,3-diyl, 4-ethyl-isothianaphthene-1,3-diyl, 5-ethyl-isothianaphthene-1,3-diyl, 4,5-diethyl-isothianaphthene-1,3-diyl, 5,6-diethyl-isothianaphthene-1,3-diyl, 4,5-diethoxy-isothianaphthene-1,2-diyl, 5,6-diethoxy-isothianaphthene-1,3-diyl, 4-propyl-isothianaphthene-1,3-diyl, 5-propyl-isothianaphthene-1,3-diyl, 4,5-diethyl-isothianaphthene-1,3-diyl, 5,6-dipropyl-isothianaphthene-1,3-diyl, 4-butyl-isothianaphthene-1,3-diyl, 5-butyl-isothianaphthene-1,3-diyl, 5-hexyl-isothianaphthene-1,3-diyl, 5-decyl-isothianaphthene-1,3-diyl, 5-methoxy-isothianaphthene-1,3-diyl, 5-ethoxy-isothianaphthene-1,3-diyl, 5-chloro-isothianaphthene-1,3-diyl, 5-bromo-isothianaphthene-1,3-diyl, and 5-trifluoromethyl-isothianaphthene-1,3-diyl.

Specific examples of the preferred chemical structure represented by general formula (9) include 1,3-dihydroisothianaphthene-5-sulfonic acid, 1,3-dihydroisothianaphthene-4-sulfonic acid, 4-methyl-1,3-dihydroisothianaphthene-5-sulfonic acid, 6-methyl-1,3-dihydroisothianaphthene-5-sulfonic acid, 5-methyl-1,3-dihydroisothianaphthene-4-sulfonic acid, 6-methyl-1,3-dihydroisothianaphthene-4-sulfonic acid, 6-ethyl-1,3-dihydroisothianaphthene-5-sulfonic acid, 6-propyl-1,3-dihydroisothianaphthene-5-sulfonic acid, 6-butyl-1,3-dihydroisothianaphthene-5-sulfonic acid, 6-hexyl-1,3-dihydroisothianaphthene-5-sulfonic acid, 6-decyl-1,3-dihydroisothianaphthene-5-sulfonic acid, 6-methoxy-1,3-dihydroisothianaphthene-5-sulfonic acid, 6-ethoxy-1,3-dihydroisothianaphthene-5-sulfonic acid, 6-chloro-1,3-dihydroisothianaphthene-5-sulfonic acid, 6-bromo-1,3-dihydroisothianaphthene-5-sulfonic acid, 6-trifluoromethyl-1,3-dihydroisothianaphthene-5-sulfonic acid, 1,3-dihydroisothianaphthene-5-methanesulfonic acid, (1′,3′-dihydro-5′-isothianaphthenyl)methanesulfonic acid, 2-(1′,3′-dihydro-5′-isothianaphthenyl)ethanesulfonic acid, (2-(1′,3′-dihydro-5′-isothianaphthenyl)ethyloxy)ethanesulfonic acid, and (2-(1′,3′-dihydro-5′-isothianaphthenyl)ethyloxy)-methanesulfonic acid, and lithium salts, sodium salts, ammonium salts, methylammonium salts, ethylammonium salts, dimethylammonium salts, diethylammonium salts, trimethylammonium salts, triethylammonium salts, tetramethylammonium salts, and tetraethylammonium salts thereof.

Specific examples of the preferred chemical structure represented by general formula (10) include 3-sulfothiophene-2,5-diyl, 3-sulfomethylthiophene-2,5-diyl, 3-(2′-sulfoethyl)-thiophene-2,5-diyl, 3-(3′-sulfopropyl)thiophene-2,5-diyl, 3-(4′-sulfobutyl)thiophen-2,5-diyl, 3-(5′-sulfopentyl)-thiophene-2,5-diyl, 3-(6′-sulfohexyl)thiophene-2,5-diyl, 3-(7′-sulfoheptyl)-thiophen-2,5-diyl, 3-(8′-sulfooctyl)-thiophene-2,5-diyl, 3-(9′-sulfononyl)thiophene-2,5-diyl, 3-(10′-sulfodecyl)thiophene-2,5-diyl, 3-(2′-sulfoethyloxy)-thiophene-2,5-diyl, 3-(3′-sulfopropoxy)-thiophene-2,5-diyl, 3-(4′-sulfobutoxy)thiophene-2,5-diyl, 3-(5′-sulfopentyloxy)-thiophene-2,5-diyl, 3-(6′-sulfohexyloxy)thiophene-2,5-diyl, 3-(7′-sulfoheptyloxy)-thiophene-2,5-diyl, 3-(8′-sulfooctyloxy)-thiophene-2,5-diyl, 3-(9′-sulfononyloxy)thiophene-2,5-diyl, 3-(10′-sulfodecyloxy)-thiophene-2,5-diyl, 3-sulfopyrrol-2,5-diyl, 3-sulfomethyl sulfopyrrol-2,5-diyl, 3-(2′-sulfoethyl)sulfopyrrol-2,5-diyl, 3-(3′-sulfopropyl)sulfopyrrol-2,5-diyl, 3-(4′-sulfobutyl)sulfopyrrol-2,5-diyl, 3-(5′-sulfopentyl)pyrrol-2,5-diyl, 3-(6′-sulfohexyl)pyrrol-2,5-diyl, 3-(7′-sulfoheptyl)pyrrol-2,5-diyl, 3-(8′-sulfooctyl)pyrrol-2,5-diyl, 3-(9′-sulfononyl)-pyrrol-2,5-diyl, 3-(10′-sulfodecyl)pyrrol-2,5-diyl, and lithium salts, sodium salts, ammonium salts, methylammonium salts, ethylammonium salts, dimethylammonium salts, diethylammonium salts, trimethylammonium salts, triethylammonium salts, tetramethylammonium salts, and tetraethylammonium salts thereof.

Specific examples of the preferred chemical structure represented by general formula (10) include 3-thienylsulfonic acid, 3-thienylmethanesulfonic acid, 2-(3′-thienyl)-ethanesulfonic acid, 3-(3′thienyl)propanesulfonic acid, 4-(3′-thienyl)butanesulfonic acid, 5-(3′-thienyl)pentanesulfonic acid, 6-(3′-thienyl)hexanesulfonic acid, 7-(3′-thienyl)-heptanesulfonic acid, 8-(3′-thienyl)octanesulfonic acid, 9-(3′-thienyl)nonanesulfonic acid, 10-(3′-thienyl)decanesulfonic acid, 2-(3′-thienyl)oxyethanesulfonic acid, 3-(3′thienyl)-oxypropanesulfonic acid, 4-(3′-thienyl)oxybutanesulfonic acid, 5-(3′-thienyl)oxypentanesulfonic acid, 6-(3′-thienyl)-oxyhexanesulfonic acid, 7-(3′-thienyl)oxyheptanesulfonic acid, 8-(3′-thienyl)oxyoctanesulfonic acid, 9-(3′-thienyl)-oxynonanesulfonic acid, 10-(3′-thienyl)oxydecanesulfonic acid, and lithium salts, sodium salts, ammonium salts, methylammonium salts, ethylammonium salts, dimethylammonium salts, diethylammonium salts, trimethylammonium salts, triethylammonium salts, tetramethylammonium salts, and tetraethylammonium salts thereof.

On the other hand, specific examples of preferred chemical structure other than those represented by general formulae (1) to (6) include poly(carbazole-N-alkanesulfonic acid), poly(phenyleneoxyalkanesulfonic acid), poly(phenylenevinylenealkanesulfonic acid), poly(phenylenevinyleneoxyalkanesulfonic acid), poly(anilinealkanesulfonic acid), poly(anilinethiaalkanesulfonic acid), poly(aniline-N-alkanesulfonic acid), and substituted derivatives thereof, a crosslinked structure of self-doping type conductive polymer through a sulfone bond indicated by 6-sulfonaphtho(2,3-c]thiophene-1,3-diyl.

The molecular weight of the self-doping type conductive polymer having an isothianaphthene skeleton or a thiophene skeleton used for producing self-doping type conductive polymers crosslinked between polymer chains in preferred embodiments of the present invention varies depending on the chemical structure of the repeating unit that constitutes the polymer and thus can not be specified generally. However, the molecular weight may be any value as far as the object of the present invention is achieved and is not limited particularly. The molecular weight, expressed in terms of number of repeating units (degree of polymerization) that constitutes the main chain, is usually within a range of 5 to 2,000, preferably 10 to 1,000 as degree of polymerization.

Particularly preferred specific examples of the self-doping type conductive polymer containing an isothianaphthene skeleton having a chemical structure represented by general formula (7) and/or an isothianaphthene skeleton having a chemical structure represented by general formula (8), used for the production of the self-doping type conductive polymer of the present invention represented by general formula (2) or (3) include:
i) polymers of 5-sulfoisothianaphthene-1,3-diyl, an example of the chemical structure represented by general formula (7), and/or lithium salt, sodium salt, ammonium salt, and triethylammonium salt thereof; and
ii) random copolymers that contain 80 mol % or more of 5-sulfoisothianaphthene-1,3-diyl, an example of the chemical structure represented by general formula (7), poly(5-sulfoisothianaphthene-1,3-diyl-co-isothianaphthen-1,3-diyl), and/or lithium salt, sodium salt, ammonium salt, and triethylammonium salt thereof.

Particularly preferred specific examples of the self-doping type conductive polymer containing a thiophene skeleton having a chemical structure represented by general formula (10), used for the production of the self-doping type conductive polymer of the present invention represented by general formula (5) or (6) include:
i) polymers of 3-(2′-sulfoethyl)thiophene-2,5-diyl, an example of the chemical structure represented by general formula (10), and/or lithium salt, sodium salt, ammonium salt and triethylammonium salt thereof; and
ii) polymers of 3-(3′-sulfopropyl)thiophene-2,5-diyl, an example of the chemical structure represented by general formula (10), and/or lithium salt, sodium salt, ammonium salt, and triethylammonium salt thereof.

The crosslinked self-doping type conductive polymer having an isothianaphthene skeleton represented by general formula (2) or (3) according to the present invention can be produced by dehydrocondensation reaction between molecules or between chains of the self-doping type conductive polymer represented by general formula (7) and/or (8) through a sulfonic acid.

On the other hand, the crosslinked self-doping type conductive polymer having a thiophene skeleton represented by general formula (5) or (6) according to the present invention can be produced by dehydrocondensation reaction between molecules or between chains of the self-doping type conductive polymer represented by general formula (10) through sulfonic acid.

The heat-treated conductive polymers derived from the self-doping type conductive polymer represented by general formula (7) and/or (8), or (10) contain sulfone bonds. That is, the heat-treated conductive polymers contain an isothianaphthene skeleton crosslinked through sulfone bonds, represented by general formula (2) or (3), or a thiophene skeleton represented by general formula (5) or (6). This is confirmed by the fact that besides the peak based on binding energy of S2p with a spin of 3/2 of sulfur atom that constitutes a thiophene ring and the peak based on binding energy of S2p with a spin of 3/2 of the sulfur atom that constitutes a sulfonate group, a new peak attributable to a sulfone bond is generated when X-ray photoelectron spectroscopy (hereinafter, abbreviated as “XPS”) analysis is performed on a coated film formed on a substrate.

The binding energy of a sulfur atom attributable to a sulfone bond has an intermediate binding energy between the binding energy of the sulfur atom that constitutes a thiophene ring and the binding energy of the sulfur atom that constitutes a sulfonate group. More specifically, the binding energy of the sulfur atom attributable to a sulfone bond has a peak by 0.5 eV to 2 eV lower than the binding energy S2p with a spin of 3/2 of the sulfur atom that constitutes a sulfonate group. When a difference between the binding energy of the sulfur atom attributable to a sulfone bond and the binding energy of the sulfur atom that constitutes a sulfonate group is 0.5 eV to 1 eV, the respective binding energy peaks are integrated and appear as a single peak with a broader half-value width, and the peaks here can then be separated by peak fitting.

The self-doping type conductive polymer crosslinked between polymer chains according to the present invention preferably is a conductive material or conductive composition of which a peak attributable to a sulfone bond is detected by XPS analysis, and more preferably is a conductive material or conductive composition having an intensity ratio (indicated as intensity ratio=peak intensity based on existence of a sulfone bond/peak intensity based on existence of sulfur atom that constitutes a sulfonic acid) within a range of 0.1 to 10. The intensity ratio within a range of 0.5 to 10 is particularly preferable.

Molar content of the crosslinked structure portion of the present invention can be calculated from the peak intensity ratio of binding energy of S2p with a spin of 3/2 of the sulfur atom determined by X-ray photoelectron spectroscopy (XPS) analysis. That is, the molar content is given by the following formula:

(Peak intensity based on the presence of a sulfone bond)/{(Peak intensity based on the presence of a sulfone bond)+(Peak intensity based on the presence of the sulfur atom constituting sulfonic acid))×100

The self-doping type conductive polymer having a crosslinked structure represented by general formula (2) in the present invention is preferably obtained by heating the self-doping type conductive polymer having a chemical structure represented by general formula (7) and/or (8). In particular, it is preferable that the self-doping type conductive polymer be produced by coating a conductive composition that contains the self-doping type conductive polymer having a chemical structure represented by general formula (7) and/or (8) on a surface of a substrate to provide a film and performing heat treatment of the substrate at a temperature within a range of 210 to 350° C. or less for 1 second to 120 minutes. The temperature range is preferably 250 to. 300° C. and heating time is preferably 10 seconds to 60 minutes, more preferably 30 seconds to 30 minutes. When the heating temperature is below 210° C., solvent resistance, in particular water resistance is hardly obtained, while above 350° C., the conductivity tends to be decreased. When the heating temperature is too short, the solvent resistance tends to be decreased while when it is too long, the conductivity tends to be decreased.

The self-doping type conductive polymer having a crosslinked structure represented by general formula (6) in the present invention is preferably obtained by heating the self-doping type conductive polymer having a chemical structure represented by general formula (10). In particular, it is preferable that the self-doping type conductive polymer be produced by coating a conductive composition that contains the self-doping type conductive polymer having a chemical structure represented by general formula (10) on a surface of a substrate to provide a film and performing heat treatment of the substrate at a temperature within a range of 120 to 250° C. and less for 1 second to 60 minutes, preferably for 10 seconds to 60 minutes. The temperature range is preferably 150 to 200° C. When the heating temperature is below 120° C., solvent resistance and so on is tends to be decreased, while above 250° C., the conductivity tends to be decreased. When the heating temperature is too short, the solvent resistance tends to be decreased while when it is too long, the conductivity tends to be decreased.

When forming a crosslinked structure by heat treatment, a step of drying a solvent and a crosslinking reaction can be performed separetly. That is, after volatilizing a solvent at a temperture lower than that for a crosslinking reaction to proceed and higher than the temperature to volatilize the solvent to be used, a crosslink structure may be formed by heating a polymer at a temperature equal to or higher than that where a crosslinking reaction proceeds. This method is preferable since the adhesiveness with a dielectric material film is enhanced through the step of drying a solvent. Specifically, though it may vary depending on the structure of the precursor self-doping type conductive polymer, when heating a self-doping type conductive polymer having a chemical structure represented by general formula (7) and/or a self-doping type conductive polymer having a chemical structure represented by general formula (8), a heating and drying step is preferably performed at a temperature within a range of 40 to less than 250° C. And the heating and drying step can be performed within a time range of from one minute to 120 minutes.

According to a preferred method, no influence of deterioration of the obtained polymer b_{y} oxidation with oxygen is observed even with heat treatment in air, so that the heat treatment can be carried out in air with no problem. Formation of sulfone bonds by heating is dehydrocondensation reaction and hence is not principally influenced by the atmosphere, so that the formation can be performed in an atmosphere of inert gas.

The heating method for obtaining a crosslinked self-doping type conductive polymer may be a method that includes coating a non-crosslinked self-doping type conductive polymer having a chemical structure represented by general formula (7), (8) or (10) on a substrate and then heating the substrate by means of a hot plate, or heating the whole substrate in an oven. It is most preferable to use an oven, which can heat the whole substrate evenly.

On the other hand, the self-doping type conductive polymer having a thiophene skeleton represented by general formula (5) forms a sulfone-crosslinked product at relatively low temperatures, so that an antistatic film can be readily formed from it by coating it on a surface of a polymer film, polymer fiber, a polymer substrate, or a polymer resin molded article and heating it.

The self-doping type conductive polymer having a crosslink between polymer chains of the present invention can be produced on a surface of a substrate most efficiently. However, the polymer can be produced also by heating by means of a hot plate or in an oven. In this manner, useful conductive covered articles such as sensors and electrodes can be produced therefrom.

The self-doping type conductive polymer having an isothianaphthene skeleton represented by general formula (2) has a very high heat resistance even when the polymer is in the form of a thin film. That is, the thickness of the self-doping type conductive polymer having an isothianaphthene skeleton represented by general formula (2) is preferably within a range of 1 nm to 1,000 nm, with 1 nm to 100 nm being particularly preferable. Generally, when a thin film is heated in air at high temperatures, deterioration of the thin film by oxidation with oxygen readily proceeds. In contrast, the thin film of the self-doping type conductive polymer having an isothianaphthene skeleton represented by general formula (2) shows no marked decrease in conductivity by the heat treatment used in the production method of the present invention even when it is a thin film having a thickness of 1 nm to 100 nm.

The surface resistance of the self-doping type conductive polymer having an isothianaphthene skeleton represented by general formula (2) may vary depending on the kind of the composition, the film thickness, heating method, heating temperature, heating time, the kind of substrate, and so on and can not be generally specified. However, it is preferably within a range of 1×10³ Ω/□ to 5×10⁹ Ω/□, more preferably 1×10⁴ Ω/□ to 5×10⁸ Ω/□ and particularly preferably 1×10⁴ Ω/□ to 5×10⁷ Ω/□. The surface resistance after coating a substrate with a conductive polymer having a chemical structure represented by general formula (5) and/or a chemical structure represented by general formula (6) and heating the coated substrate varies depending on the kind of the composition, thickness, heating method, heating temperature, heating time, the kind of the substrate, and so on and hence can not be generally specified. However, it is preferably within a range of 1/10 times to 1,000 times, more preferably 1/10 times to 100 times the initial (before heating) surface resistance.

Since the self-doping type conductive polymer having a thiophene skeleton represented by general formula (5) can be readily formed by heating at low temperatures, it is particularly effective for use in organic devices in which presence of water in a thin film causes deterioration of the thin film. The thickness of the self-doping type conductive polymer having a thiophene skeleton represented by general formula (5) is preferably within a range of 1 nm, to 1,000 nm, particularly preferably 1 nm to 100 nm.

The surface resistance of the self-doping type conductive polymer having a thiophene skeleton represented by general formula (5) may vary depending on the kind of the composition, the film thickness, heating method, heating temperature, heating time, the kind of substrate, and so on and can not be generally specified. However, it is preferably within a range of 1×10³ Ω/□ to 5×10⁹ Ω/□, and more preferably 1×10⁴ Ω/□ to 5×10⁸ Ω/□. The surface resistance of a substrate coated with a conductive polymer having a chemical structure represented by general formula (5) after heat treatment varies depending on the kind of the composition, the film thickness, heating method, heating temperature, heating time the kind of the substrate, and so on and hence can not be generally specified. However, it is preferably within a range of 1/10 times to 1,000 times, more preferably 1/10 times to 100 times the initial (before heating) surface resistance.

The self-doping type conductive polymer having an isothianaphthene skeleton represented by general formula (2) and the self-doping type conductive polymer having a thiophene skeleton represented by general formula (5) are usually used singly. However, when high conductivity is required or when sulfone crosslinking is effected at heating temperatures at 200° C. or less to provide solvent resistance, these polymers can be blended with a self-doping type conductive polymer having a structure represented by general formula (7), (8), or (10) and heated to form a self-doping type conductive polymer having the chemical structure represented by general formula (7) and/or (8), or (10) that are mutually crosslinked through sulfone. A preferable heating time when the self-doping type conductive polymer having two or more of the above-mentioned structures crosslinked is produced may vary depending on the chemical structure and compositional ratios of the respective self-doping type conductive polymer components and can not be generally specified. However, the heating temperature is preferably 150 to 300° C., particularly preferably 200 to 250° C.

A self-doping type conductive polymer that serves as a precursor of a self-doping type conductive polymer having crosslinks between polymer chains may be used by applying onto the entirety or an arbitrary part of the dielectric film which becomes a cathode part. FIG. 7 shows an example wherein the cathode-formed portion is entirely impregnated.

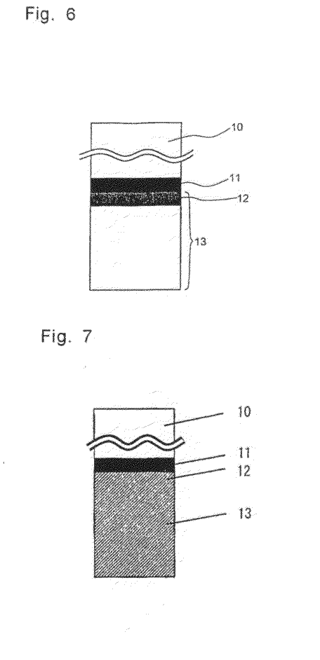

In FIG. 7, the coating range of the conductive polymer (12) having crosslinks between polymer chains is the entirety of a cathode-formed portion (13) in a chemically-formed aluminum foil which portion is insulated from an anode-formed portion (10) by an insulating material (masking) (11). Further, the self-doping type conducting polymer may be used by forming a crosslink between polymer chains after being applied on the insulating material which ensures the insulation/separation between the anode and the cathode in a valve-acting metal having fine pores, or at least a part of the dielectric film on the side of a cathode adjacent to the insulating material. FIG. 6 shows an example wherein the cathode-formed portion is partially coated with the polymer solution. In FIG. 6, the chemically-formed aluminum foil has a coating range of the conductive polymer (12) having crosslinks between polymer chains on at least a part of the dielectric film on the side of a cathode adjacent to the insulating material (11) to ensure the insulation/separation between an anode-formed portion (10) and a cathode-formed portion (13) in a valve-acting metal having fine pores. The present inventors have found that when the self-doping type conductive polymer having a crosslink between polymer chains selectively penetrates into the defective portion in the porous layer in the anode substrate where the penetration of the insulating material is insufficient, the polymer forms a second solid electrolyte layer in the vicinity of or in the anode part since the polymer fills in the defective portion; or the water-repellent/water-resisting property of the penetrated polymer prevents the oxidizer-containing solution from soaking up to the anode part attributable to the defective portion of the insulating material. In this case, it enables to eliminate a short-circuit failure and to reduce leakage current by preventing formation of an electrically-conducting path between the anode part and the cathode part through the defective portion of an insulating material.

It is preferable that the self-doping type conductive polymer having a crosslink between polymer chains of the present invention is applied so that it partially laps over the surface of the insulating material. It allows the polymer to penetrate, into a porous layer along with the insulating material and to reach the defective portion wherein the insulating material is insufficient and thereby to be applied on the defective portion. When there is a sufficient solid content of the polymer for defective portions, the polymer will fill in the portion. Even if the solid content is insufficient, the water-repellent property of the self-doping type conductive polymer having a crosslink between polymer chains can prevent the oxidizer-containing solution from soaking up to an anode part.

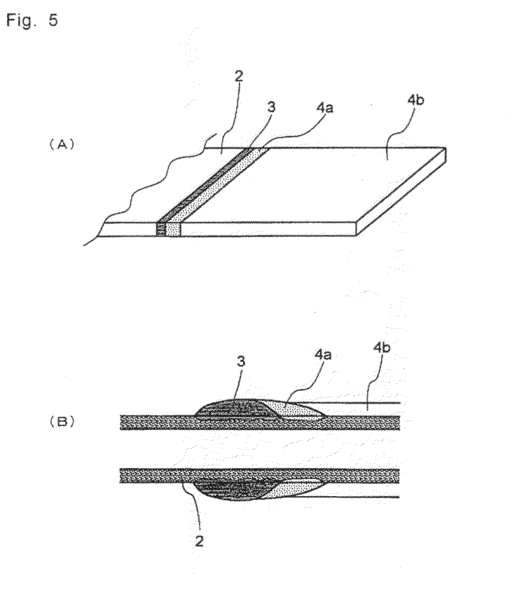

The coating width of a self-doping type conductive polymer serving as a precursor of the one having a crosslink between polymer chains is within a range of an anode substrate (1) in which a porous layer exists. Generally, a dielectric film (2) is formed on the surface of the substrate (1). A self-doping type conductive polymer serving as a precursor of the one having a crosslink between polymer chains is coated on the outer surface of the dielectric film to form a solid semiconductor layer (4), a masking layer (3) comprising an insulating material is generally provided to ensure insulation between the solid electrolyte (4) (cathode part) and the anode substrate (1), and thereby a solid electrolytic capacitor (element) of the present invention is fabricated. In a capacitor (element) having a masking layer (3) comprising an insulating material to ensure the insulation/separation between an anode and a cathode in a valve-acting metal having a porous layer, a self-doping type conductive polymer having a crosslink between polymer chains is preferably formed on at least a part of the dielectric layer on the side of a cathode adjacent to the insulating material. That is, for example, a self-doping type conductive polymer serving as a precursor of the one having a crosslink between polymer chains is preferably coated in an arbitrary width on an arbitrary part or entirety of the circumference of the dielectric film. In such a case, with respect to an embodiment corresponding to one shown in FIG. 6, for example, in a capacitor element having a shape of a thin rectangular plate, a first solid electrolyte layer (4a) comprising a self-doping type conductive polymer is provided along with a masking layer on the cathode side, and further a second solid electrolyte layer (4b) may be provided on the first solid electrolyte layer as in FIG. 5(A) by the method as described later. As shown in FIG. 5(B), which is a cross-sectional view of the rectangular element of FIG. 5(A) cut off in a longitudinal direction, typically, the first solid electrolyte layer (4a) is provided so that it partially laps over the masking layer (3). The second solid electrolyte layer (4b) is also typically provided so that it partially laps over the first solid electrolyte layer (4a). The width of these overlapping portions is generally 0 or more and less than the width of the underlying layers.

Here, the method for coating the first solid electrolyte layer (4a) is not particularly limited. The layer may be coated by transferring a material to a means for transferring printing having an appropriate width (for example, a thin blade) and pressing the means to an intended part; by brushing; by a dispenser; by ink jet printing or the like. These methods may be arbitrarily selected for different purposes. For example, in the case of transferring printing, the materials may be transferred onto a circumference of a disk-shape member instead of using a blade and may be further transferred in the vicinity of a masking layer (3). In an embodiment corresponding to one shown in FIG. 7, the first solid electrolyte layer (4a) may be formed by dipping in the same way as in the second solid electrolyte layer (4b) as described later.

The coating width of a self-doping type conductive polymer serving as a precursor of the one having a crosslink between polymer chains is within a range of from 0.1 to 10 times that of the insulating material, preferably from 0.1 to 3 times, more preferably from 0.5 to 2 times. The width may not be constant unless the coating reaches to the anode present on the opposite side of the insulating material. Further, the polymer may not necessarily be coated on all circumferences but, when coating a significant quantities of the self-doping type conductive polymer serving as a precursor of the one having a crosslink between polymer chains, coating the polymer on both sides of the insulating material has substantially the same effect.

Though the coating amount of the self-doping type conductive polymer serving as a precursor of the one having a crosslink between polymer chains may vary depending on the surface area of the porous layer of a dielectric film, the polymer is preferably coated in a range within 0.01 to 50 mg/cm², more preferably within 0.1 to 10 mg/cm².

Though the concentration of the solusion containing the self-doping type conductive polymer serving as a precursor of the one having a crosslink between polymer chains may vary depending on the chemical structure of the self-doping type conductive polymer serving as a precursor, kinds of a solvent or the like, it is preferably from 0.01 to 10% by mass, more preferably from 0.1 to 5% by mass. As schematically shown in FIG. 5(B), generally the masking layer (3) penetrates into the dielectric film (2), and it is preferable that the first solid electrolyte layer (4a) penetrates thereinto within the region where the masking layer penetrates. In order to sufficiently exert a water-repellent property and thereby to prevent penetration of the oxidizer-containing solution, the concentration of the solution containing the self-doping type conductive polymer serving as a precursor is preferably 0.01% by mass or more. Meanwhile, when the concentration exceeds 10% by mass, the solution viscosity may increase in some cases, so that there is a possibility of hindering the solution from penetrating into a fine defective portions in a porous layer.

Hereinafter, the method of forming the second solid electrolyte layer is explained.

The method of forming the second solid electrolyte layer in the present invention is based on chemical oxidation polymerization of an organic polymeric monomer that includes the steps of dipping a valve-acting metal porous substrate in an oxidizer solution, drying, and gradually increasing the concentration of the oxidizer solution on the substrate. In the chemical oxidation polymerization method of the present invention, the monomer is attached to a porous dielectric film of an anode substrate, oxidative polymerization is caused to proceed in the presence of a compound that can serve as a dopant to a conductive polymer, the resultant polymer composition as solid electrolyte is formed on the surface of the dielectric material.

The solid electrolyte layer made of the conductive polymer formed by the method of the present invention is of a fibrillar structure or of a lamellar (thin layer) structure. These structures include overlaps between polymer chains over a wide range. In the present invention, it is found that by setting the total thickness of a solid electrolyte layer within a range of about 10 μm to about 100 μm, the space in the layer structure of a polymer 0.01μm to 5 μm, preferably 0.05 μm to 3 μm, more preferably 0.1 μm to 2 μm, and the space occupancy between the layers of the solid electrolyte to the whole polymerized film within a range of 0.1% to 20%, electron hopping between the polymer chains becomes easy to increase electric conductivity, and increasing the characteristics of the solid electrolyte layer, such as low impedance.

Step 2 in which a substrate is dipped in a solution containing a monomer used in the present invention and the dipped substrate is dried is carried out to supply the monomer on the surface of a dielectric material and on the polymer composition. Further, to uniformly attach the monomer on the surface of the dielectric material and on the polymer composition, the substrate after dipping in the monomer-containing solution is left to stand in air for a predetermined time to vaporize the solvent. Although this condition may vary depending on the kind of monomer-containing solvent, the vaporization is carried out at a temperature from about 0° C. or more to the boiling point of the solvent. The standing time, which may vary depending on the kind of solvent, is about 5 seconds to about 15 minutes. For example, in the case of alcoholic solvents, a standing time of 5 minutes or less is sufficient. By providing the standing time, the monomer can be uniformly attached on the surface of the dielectric material, so that contamination when dipping the substrate in the oxidizer-containing solution in the subsequent step can be minimized.

The supply of the monomer can be controlled by the kind of the solvent used in the monomer-containing solution, the concentration and temperature of the monomer-containing solution, dipping time, and so on.

The dipping time applied in Step 2 can be any time if it is no shorter than a time which is sufficient for the monomer component in the monomer-containing solution to be attached to the surface of the dielectric material on the metal foil substrate. Usually, the dipping time is less than 15 minutes, preferably 0.1 second to 10 minutes, more preferably 1 second to 7 minutes.

On the other hand, the dipping temperature is preferably −10° C. to 60° C., particularly preferably 0° C. to 40° C. When the dipping temperature is below −10° C., it takes a long time for the solvent to be vaporized so that the reaction time may take a long time. At above 60° C., vaporization of the solvent and the monomer becomes innegligible so that it is difficult to control the concentration of the solution.

The concentration of the monomer-containing solution is not particularly limited and monomer-containing solutions of any desired concentrations may be used. However, it is preferable that the monomer-containing solution is used in a concentration of 3 to 70 mass % that provides excellent penetration into the pores of a valve-acting metal, more preferably 25 to 45 mass.

Examples of the solvent that can be used in Step 2 include ethers such as tetrahydrofuran (THF), dioxane, and diethyl ether; ketones such as acetone and methyl ethyl ketone; aprotic polar solvents such as dimethylformamide, acetonitrile, benzonitrile, N-methylpyrrolidinone (NMP), and dimethyl sulfoxide (DMSO); esters such as ethyl acetate and butyl acetate; non-aromatic chlorine-containing solvents such as chloroform and methylene chloride; nitro compounds such as nitromethane, nitroethane, and nitrobenzene; alcohols such as methanol, ethanol, and propanol, water, and mixed solvents thereof. Preferably, alcohols or ketones or mixtures thereof are used.

In the present invention, the monomers are oxidation-polymerized by Step 3 in which a substrate is dipped in an oxidizer-containing solution and held in air at a temperature within a predetermined range for a predetermined time. To obtain a polymer film having a denser form, a method mainly based on oxidation polymerization including holding the substrate in air is preferred. The temperature at which the dipped substrate is held in air may vary depending on the kind of the monomer and may be 5° C. or less, for example, in the case of pyrrole and in the case of thiophene-based monomers, a holding temperature of about 30° C. to about 60° C. is necessary.

The polymerization time depends on the amount of attached monomer at the time of dipping. The amount of attached monomer may vary depending on the concentration and viscosity of the solution containing the monomer and the oxidizer and can not be generally specified. However, generally, when the amount of the attached monomer at one time is smaller, the polymerization time can be shortened while a larger amount of the attached monomer at one time will result in taking a longer polymerization time. In the method of the present invention, the polymerization time in a single run is 10 seconds to 30 minutes, preferably 3 minutes to 15 minutes.

The dipping time applied to Step 3 can be any time if it is no shorter than a time which is sufficient for the oxidizer component to be attached to the surface of the dielectric material on the metal foil substrate. Usually, the dipping time is less than 15 minutes, preferably 0.1 second to 10 minutes, more preferably 1 second to 7 minutes.

The oxidizer used in Step 3 includes an oxidizer based on an aqueous solution and an oxidizer based on an organic solvent. Examples of the aqueous solution-based oxidizer that can be preferably used in the present invention include peroxodisulfuric acid and Na salt, K salt, and NH, salt thereof, cerium (IV) nitrate, cerium (IV) ammonium nitrate, iron (III) sulfate, iron (III) nitrate, and iron (III) hydrochloride. On the other hand, examples of the organic solvent-based oxidizers include a ferric salt of organic sulfonic acid, for example, iron (III) dodecylbenzenesulfonate and iron (III) p-toluenensulfonate.

Examples of the solvent in the solutions that can be used in Step 3 of the method of the present invention include ethers such as tetrahydrofuran (THF), dioxane, and diethyl ether; ketones such as acetone and methyl ethyl ketone; aprotic polar solvents such as dimethylformamide, acetonitrile, benionitrile, N-methylpyrrolidinone (NMP), and dimethyl sulfoxide (DMSO); alcohols such as methanol, ethanol, and propanol, water, and mixed solvents thereof. Preferably, water, alcohols or ketones or mixtures thereof are used.

Note that the concentration of the oxidizer solution is preferably 5 to 50 mass %, and the temperature of the oxidizer solution is preferably −15° C. to 60° C. In Step 3, a suspension containing organic fine particles is advantageously used. The organic fine particles are effective in aiding the supply of the oxidizer and monomer to a smooth surface of a polymer film having pores filled with polymer film by allowing the fine particles to remain on the surface of the dielectric material and on the polymer composition. In particular, by using soluble organic fine particles, the soluble organic fine particles can be dissolved and removed after a solid electrolyte layer is formed, so that the reliability of the capacitor element can be increased.

Examples of the solvent used in the process of dissolving and removing the organic fine particles include water; alcohols such as methanol, ethanol, and propanol; ketones such as acetone and methyl ethyl ketone; aprotic polar solvents such as dimethylformamide, N-methyl-2-pyrrolidinone, and dimethyl sulfoxide. Water, or alcohols, or mixed solvents thereof are preferable. Solvents that can dissolve also the oxidizer are more preferable since the dissolution and removal of the organic fine particles can be carried out simultaneously with the removal of the oxidizer.

Note that soluble inorganic fine particles that can be removed by using strong acids are not desirable since they give damages to the dielectric material film of the surface of the valve-acting metal by dissolving or corroding the film.

The soluble organic fine particles have an average particle diameter (D₅₀) within a range of 0.1 μm to 20 μm, more preferably 0.5 μm to 15 μm. When the average particle diameter (D₅₀) exceeds 20 μm, the gaps formed in the polymer film become undesirably larger while when the average particle diameter (D₅₀) is less than 0.1 μm, the effect of increasing the amount of attached solution is not obtained and the effect of the attached solution is on the same level as that of water.

Specific examples of the soluble organic fine particles include particles of aliphatic sulfonic acid compounds, aromatic sulfonic acid compounds, aliphatic carboxylic acid compounds, aromatic carboxylic acid compounds, peptide compounds and/or salts thereof. The aromatic sulfonic acid compounds, aromatic carboxylic acid compounds, and peptide compounds are preferably used.

More specifically, examples of the aromatic sulfonic acid compounds include benzenesulfonic acid, toluenesulfonic acid, naphthalenesulfonic acid, anthracenesulfonic acid, anthraquinonesulfonic acid and/or salts thereof; examples of the aromatic carboxylic acid compounds include, more specifically, benzoic acid, toluenecarboxylic acid, naphthalenecarboxylic acid, anthracenecarboxylic acid, anthraquinonecarboxylic acid and/or salts thereof; examples of peptides compounds include, more specifically, surfactin, iturin, pripastatin, and serrawettin.

In the method of the present invention, it is necessary to control the time of impregnation in order for a conductive polymer composition to be formed to have a thickness that is resistant to humidity, heat, stress and so on.

One of preferred steps for forming the second solid electrolyte according to the present, invention is a method of repeating Step 2 and Step 3 as one cycle. By repeating this cycle 3 times or more, preferably 8 to 30 times for one anode substrate, a desired solid electrolyte layer can be formed. Note that step 2 and Step 3 can be performed in a reverse order.

According to the present invention, as indicated by the examples described later on, a polymer of, for example, poly(3,4-ethylenedioxythiophene) can be obtained by impregnating an aluminum foil having a dielectric material film in a solution of, for example, 3,4-ethylenedioxy-thiophene(EDT) in isopropyl alcohol (IPA) and air-drying the impregnated dielectric material film, impregnating the foil in about 20 mass % of the oxidizer solution (ammonium peroxide) and then heating the dried dielectric material at about 40° C. for 10 minutes, or repeating this process.

The conductive polymer that forms a solid electrolyte used in the present invention is a polymer of an organic polymer monomer having a it-electron conjugated structure having a degree of polymerization of preferably 2 or more and 2,000 or less, more preferably 3 or more and 1,000 or less, still more preferably 5 or more and 200 or less. Specific examples thereof include conductive polymers containing a structure represented by a compound having a thiophene skeleton, a compound having a polycyclic sulfide skeleton, a compound having a pyrrole skeleton, a compound having a furan skeleton, or a compound having an aniline skeleton as a repeating unit.

Examples of the monomer having a thiophene skeleton include thiophene derivatives such as 3-methylthiophene, 3-ethylthiophene, 3-propylthiophene, 3-butylthiophene, 3-pentylthiophene, 3-hexylthiophene, 3-heptylthiophene, 3-octylthiophene, 3-nonylthiophene, 3-decylthiophene, 3-fluorothiophene, 3-chlorothiophene, 3-bromothiophene, 3-cyanothiophene, 3,4-dimethylthiophene, 3,4-diethylthiophene, 3,4-butylenethiophene, 3,4-methylenedioxythiophene, and 3,4-ethylenedioxythiophene. These compounds are generally commercially available compounds or can be provided by a known method (for example, Synthetic Metals, 1986, Vol. 15, page 169).

Specific examples of the monomer having a polycyclic sulfide skeleton that can be used include compounds having a 1,3-dihydro polycyclic sulfide (alias name, 1,3-dihydrobenzo[c]thiophene) skeleton, and compounds having a 1,3-dihydronaphtho[2,3-c]thiophene skeleton. Further, compounds having a 1,3-dihydroanthra[2,3-c]thiophene skeleton, and compounds having a 1,3-dihydronaphthaceno[2,3-c]thiophene skeleton may be mentioned. These compounds can be prepared by a known method, for example the method described in Japanese Patent Application Laid-open No. 8-3156.

Further, 1,3-dihydrophenanthra[2,3-c]thiophene derivatives that are compounds having a 1,3-dihydronaphtho[1,2-c]thiophene skeleton, and 1,3-dihydrobenzo[a]anthraceno[7,8-c]thiophene derivatives that are compounds having a 1,3-dihydrotriphenylo[2,3-c]thiophene skeleton can also be used.

Compounds that optionally contain nitrogen or N-oxide in the condensed ring can also be used. Examples thereof include 1,3-dihydrothieno[3,4-b]quinoxaline, 1,3-dihydrothieno[3,4-b]quinoxaline-4-oxide, and 1,3-dihydrothieno[3,4-b]quinoxaline-4,9-dioxide.

Examples of the monomer having a pyrrole skeleton include derivatives such as 3-methylpyrrole, 3-ethylpyrrole, 3-propylpyrrole, 3-butylpyrrole, 3-pentylpyrrole, 3-hexylpyrrole, 3-heptylpyrrole, 3-octylpyrrole, 3-nonylpyrrole, 3-decylpyrrole, 3-fluoropyrrole, 3-chloropyrrole, 3-bromopyrrole, 3-cyanopyrrole, 3,4-dimethylpyrrole, 3,4-diethylpyrrole, 3,4-butylenepyrrole, 3,4-methylenedioxypyrrole, and 3,4-ethylenedioxypyrrole. These compounds are generally commercially available compounds or can be provided by a known method.

Examples of the monomer having a furan skeleton include derivatives such as 3-methylfuran, 3-ethylfuran, 3-propylfuran, 3-butylfuran, 3-pentylfuran, 3-hexylfuran, 3-heptylfuran, 3-octylfuran, 3-nonylfuran, 3-decylfuran, 3-fluorofuran, 3-chlorofuran, 3-bromofuran, 3-cyanofuran, 3,4-dimethylfuran, 3,4-diethylfuran, 3,4-butylenefuran, 3,4-methylenedioxyfuran, and 3,4-ethylenedioxyfuran. These compounds are generally commercially available compounds or can be provided by a known method.

Examples of the monomer having an aniline skeleton include derivatives such as 2-methylaniline, 2-ethylaniline, 2-propylaniline, 2-butylaniline, 2-pentylaniline, 2-hexylaniline, 2-heptylaniline, 2-octylaniline, 2-nonylaniline, 2-decylaniline, 2-fluoroaniline, 2-chloroaniline, 2-bromoaniline, 2-cyanoaniline, 2,5-dimethylaniline, 2,5-diethylaniline, 2,3-butyleneaniline, 2,3-methylenedioxyaniline, and 2,3-ethylenedioxyaniline. These compounds are generally commercially available compounds or can be provided by a known method.

Among these, compounds having a thiophene skeleton or a polycyclic sulfide skeleton are preferable and 3,4-ethylenedioxythiophene (EDT) and 1,3-dihydroisothianaphthene are particularly preferable.

The conditions for polymerization and so on of the compounds selected from the above-mentioned compound groups are not particularly limited, and the polymerization methods can be performed with ease by preliminarily confirming preferable conditions by simple experiments.

Alternatively, compounds selected from the above-mentioned monomer groups can be used in combination and the solid electrolyte can be formed as a copolymer. In this case, the compositional ratios of polymerizable monomers and so on depend on the polymerization conditions and so on, and preferable compositional ratios, polymerization conditions can be confirmed by simple tests.

For example, a method that includes coating an EDT monomer and an oxidizer, preferably in the form of a solution, on an oxide film layer of a metal foil separately in tandem or together to form the solid electrolyte layer can be utilized (Japanese Patent No. 3040113, U.S. Pat. No. 6,229,689).

3,4-ethylenedioxythiophene (EDT) that is preferably used in the present invention is readily dissolved in the above-mentioned monohydric alcohols but has poor compatibility with water, so that when in contact with a high-concentration aqueous solution of oxidizer, polymerization proceeds favorably on the interface of EDT, so that a conductive polymer solid electrolyte layer having a fibrillar or lamellar (thin layer) structure is formed.

In the production method of the present invention, examples of the solvent that is used for washing after formation of a solid electrolyte layer include ethers such as tetrahydrofuran (THF), dioxane, and diethyl ether; ketones such as acetone and methyl ethyl ketone; aprotic polar solvents such as dimethylformamide, acetonitrile, benzonitrile, N-methylpyrrolidinone (NMP), and dimethyl sulfoxide (DMSO); esters such as ethyl acetate and butyl acetate; non-aromatic chlorine-contained solvents such as chloroform and methylene chloride; nitro compounds such as nitromethane, nitroethane, and nitrobenzene; alcohols such as methanol, ethanol, and propanol; organic acids such as formic acid, acetic acid, and propionic acid; anhydrides of the organic acids (for example, acetic anhydride), water, and mixed solvents thereof. Preferably, water, alcohols or ketones or mixtures thereof are used.

The solid electrolyte thus formed has an electric conductivity within a range of about 0.1 S/cm to about 200 S/cm, preferably about 1 S/cm to about 150 S/cm, more preferably about 10 S/cm to about 100 S/cm.

It is preferable that a conductor layer is provided on the conductive polymer composition layer thus formed to improve electric contact with a cathode lead terminal. The conductor layer is formed, for example, by conductive paste, plating, vapor deposition, application of a conductive resin film, and so on.

In the present invention, the conductive layer can be compressed after its formation. For example, in the case of a conductor layer that contains an elastic body, the conductor layer can be made thinner by plastic deformation as a result of compression. This also has the effect of smoothing the surface of the conductive layer.

The solid electrolytic capacitor thus obtained usually are connected with lead terminals and provided with a resin mold, a resin case, an exterior case made of a metal, or an exterior by resin dipping or the like, to give capacitor products for various purposes.

In the present invention, after a conductive layer is formed, the resultant capacitor elements may be laminated, leads are connected to the laminate body and the entire elements are sealed to produce a laminate-type solid electrolytic capacitor. In this case, as shown in FIG. 2, capacitor elements 1 may be laminated on both sides of a lead portion 7 (a lead frame in an embodiment shown in the figure), or a plurality of elements may be bonded with a conductive paste and the like and laminated on one side or both sides of the lead portion.

### Examples

Hereinafter, representative examples of the present invention are presented and the present invention will be explained in more detail. It should be noted that these examples are merely exemplary and the present invention should not be construed as being limited thereto.

### 1) Synthesis of a Self-Doping Type Conductive Compound:

A self-doping type conductive polymer compound of general formula (7) in which R¹ to R³ and M are each a hydrogen atom, no B¹ is present and a sulfonate group is directly bonded, i.e., poly(5-sulfo-isothianaphthene-1,3-diyl), was synthesized referring to the method disclosed in Japanese Patent Application Laid-open No. 7-48436.

The self-doping type conductive polymer compound of general formula (10) in which B¹ is trimethylene, i.e., poly(3-(3′-sulfopropyl)thiophene-2,5-diyl), was synthesized referring to the method described in Japanese Patent Application No.2-189333.

### 2) Preparation of Conductive Composition

### Conductive Composition 1:

To 100 ml of 2 mass % aqueous poly(5-sulfo-isothianaphthene-1,3-diyl) was added 7.0 g of 1N ammoniacal water to adjust pH to 4.4.

### Conductive Composition 2:

To 100 ml of 3 mass % aqueous poly(5-sulfo-isothianaphthene-1,3-diyl) was added 10.5 g of 1N ammoniacal water to adjust pH to 4.3.

### Conductive Composition 3:

To 100 ml of 5 mass % aqueous poly(5-sulfo-isothianaphthene-1,3-diyl) was added 17.5 g of 1N ammoniacal water to adjust pH to 4.4.

### Conductive Composition 4:

To 100 ml of 1 mass % aqueous poly(3-(3′-sulfopropyl)-thiophene-2,5-diyl) was added 3.1 g of 1N ammoniacal water to adjust pH to 4.3.

### Conductive Composition 5:

To 100 ml of 3 mass % aqueous poly(3-(3′-sulfopropyl)-thiophene-2,5-diyl) was added 9.3 g of 1N ammoniacal water to adjust pH to 4.0.

### Conductive Composition 6:

75 ml of Conductive Composition 3 and 25 ml of Conductive Composition 4 were mixed with each other.

### 3) pH Measurement:

The pH of the aqueous solution of self-doping type conductive polymer was measured by using glass electrode type hydrogen ion concentration meter pH METER F-13 (manufactured by Horiba Seisakusho).

### 4) Method of Heat Treatment:

Chemically formed aluminum foil dipped or coated with a conductive composition was heated by charging the foil in an oven model ACS-A manufactured by ISUZU SEISAKUSHO.

### 5) X-ray Photoelectron Spectroscopy (XPS):

XPS was measured by using AXIS-Ultra manufactured KRATOS.

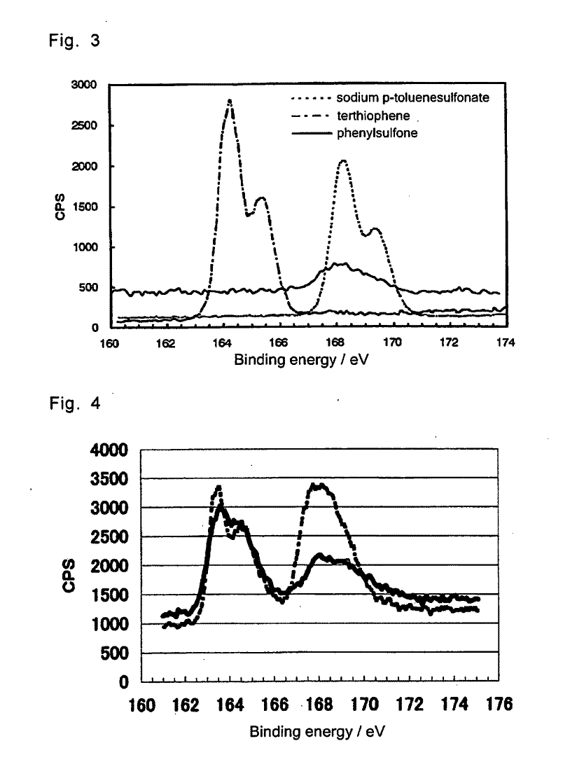

To identify the peak position of each type of sulfur atoms, thiophene trimer (terthiophene) was used as a standard sample for a sulfur atom derived from a thiophene ring, sodium p-toluenesulfonate was used as a standard sample for a sulfur atom derived from sulfonic acid, and phenylsulfone was used as a standard sample for a sulfur atom derived from a sulfone bond. (FIG. 3)

### 6) Evaluations of Water Resistance and Solvent Resistance:

Evaluations of water resistance and solvent resistance were preformed as follows.

Chemically formed aluminum foil after heating was charged into ultrapure water, acetone, N-methylpyrrolidinone, polyethylene glycol monomethyl ether, and occurrence of elution was checked after 1 hour.

### Example 1

Chemically formed aluminum foil was cut to pieces of a size of 3.5 mm along short axis direction×11 mm along long axis direction. A polyimide solution was coated on both sides of the foil in a width of 1 mm circumferentially such that the foil is sectioned into two 5 mm portions along the long axis direction and dried to form masking. One of the portions the size of 3.5 mm×5 mm (cathode formed portion) of the chemically formed foil thus obtained was dipped in 10 mass % aqueous ammonium adipate solution and the cut portion was chemically formed by applying a voltage of 3.8 V to form a dielectric material oxide film. Then, the portion of the aluminum foil thus treated was dipped in Conductive Composition 1 for 5 seconds and dried at room temperature for 5 minutes. The spectrum showing the S2p binding energy determined by measuring through X-ray photoelectron spectroscopy (XPS) the surface of the dielectric layer provided on a layer having fine pores in the chemically-formed aluminum foil after drying is shown in dash line in FIG. 4. Subsequently, dehydrocondensation reaction was performed at 300° C. for 15 minutes to allow crosslinking to proceed to form a self-doping type conductive polymer with the polymer chains thereof being crosslinked therebetween on a surface of the dielectric film (Step 1). The mol content of a crosslinked structure portion determined from FIG. 4 was 30%. The covered portion of the obtained aluminum foil was dipped in pure water for 1 hour. However no elution of the self-doping type conductive polymer was observed. The spectrum showing the S2p binding energy determined by measuring through X-ray photoelectron spectroscopy (XPS) the surface of the dielectric layer provided on a layer having fine pores in the chemically-formed aluminum foil after the heating treatment is shown in solid line in FIG. 4. Subsequently, the aluminum foil was dipped in an isopropyl alcohol (IPA) solution having dissolved therein 2.0 mol/l of 3,4-ethylenedioxythiophene for 5 seconds, and then dried at room temperature for 5 minutes (Step 2). Then, the foil was dipped in an aqueous solution of 1.5 mol/l ammonium persulfate adjusted such that sodium 2-anthraquinosulfonate (D₅₀=11 μm; measured using a master sizer manufactured by CISMEX CO.) was 0.07 mass % for 5 seconds. Subsequently, the aluminum thus treated was left to stand in air at 40° C. for 10 minutes to perform oxidative polymerization (Step 3). Further, the dipping and polymerization steps were repeated in total 22 times to form a solid electrolyte layer of the conductive polymer on the outer surface of the aluminum foil. Finally produced poly(3,4-ethylenedioxythiophene) was washed in hot water at 50° C., and thereafter, dried at 100° C. for 30 minutes to form a solid electrolyte layer.

Then, the 3.5 mm×5 mm portion on which the solid electrolyte layer was formed was dipped in 15 mass % aqueous solution of ammonium adipate to form a contact point for the anode on the valve-acting metal foil where no solid electrolyte layer was formed, and a voltage of 3.8 V was applied to perform chemical forming again.

Then, carbon paste and silver paste were attached on the portion of the aluminum foil where the conductive polymer composition layer was formed and two sheets of the above-mentioned aluminum foil were laminated and a cathode lead terminal was connected thereto. Further, an anode lead terminal was connected by welding to the portion where no conductive polymer composition layer was formed. The obtained element was sealed with epoxy resin and then rated voltage (2 V) was applied at 125° C. to perform aging for 2 hours. In this manner, total 30 capacitors were completed.

The 30 capacitor elements thus obtained were measured for capacity and loss coefficient (tan δ×100(%))at 120 Hz, equivalent series resistance (ESR), and leakage current as initial characteristics. Note that leakage current was measured after 1 minute from the application of the rated voltage. Table 1 shows average values of the measured values, and percentage defective when 0.002 CV or more leakage current was judged to be defective. Here, the average values of leakage current were calculated after removing defective products.

Subsequently, 20 acceptable products were mounted on a substrate provided with copper wiring that had been printed with solder paste so that the capacitor elements were placed on the paste and the substrate was passed through a reflow oven (peak temperature: 250° C.) to realize soldering. The capacitors soldered on the substrate were measured for capacity and loss coefficient (tan δ×100(%)) at 120 Hz, equivalent series resistance (ESR), and leakage current. Note that leakage current was measured after 1 minute from the application of the rated voltage. Table 2 shows average values of the measured values, and percentage defective when 0.002 CV or more leakage current was judged to be defective. Here, the average values of leakage current were calculated after removing defective products.

### Example 2

One of the portions the size of 3.5 mm×5 mm (cathode formed portion) of the chemically formed aluminum foil wherein a masking was provided in the same way as in Example 1 was treated in the same way as in Example 1 and the cut portion thereof was chemically formed to form a dielectric oxidized film. Then the chemically formed portion was dipped in Conductive Composition 1 for 5 seconds and dried at room temperature for 5 minutes and then dehydrocondensation reaction was performed at 300° C. for 15 minutes to allow crosslinking to proceed to form a self-doping type conductive polymer with the polymer chains thereof being crosslinked therebetween on a surface of the dielectric film (Step 1).

Further, a solid electrolyte was formed in the same manner as in Example 1 except that this operation was repeated once again.

Then, re-chemical-forming, coating of carbon paste and silver paste, lamination, connection of cathode lead terminal, sealing with epoxy resin, and aging operations were carried out in the same manner as in Example 1 to thereby complete total 30 capacitors. The obtained capacitor elements were subjected to evaluation of characteristics in the same manner as in Example 1. Tables 1 and 2 show the results.

### Example 3

One of the portions the size of 3.5 mm×5 mm (cathode formed portion) of the chemically formed aluminum foil wherein a masking was provided in the same way as in Example 1 was treated in the same way as in Example 1 and the cut portion thereof was chemically formed to form a dielectric oxidized film. Then total 30 capacitors were completed in the same manner as in Example 1 except that a chemically formed aluminum foil was dipped in Conductive Composition 2 for 5 seconds and dried at room temperature for 5 minutes and then dehydrocondensation reaction was performed at 250° C. for 30 minutes to allow crosslinking to proceed to form a self-doping type conductive polymer with the polymer chains thereof being crosslinked therebetween on a surface of the dielectric film. The obtained capacitor elements were subjected to evaluation of characteristics in the same manner as in Example 1. Tables 1 and 2 show the results.

### Example 4

One of the portions the size of 3.5 mm×5 mm (cathode formed portion) of the chemically formed aluminum foil wherein a masking was provided in the same way as in Example 1 was treated in the same way as in Example 1 and the cut portion thereof was chemically formed to form a dielectric oxidized film. Then total 30 capacitors were completed in the same manner as in Example 1 except that a chemically formed aluminum foil was dipped in Conductive Composition 3 for 5 seconds and dried at room temperature for 5 minutes and then dehydrocondensation reaction was performed at 250° C. for 30 minutes to allow crosslinking to proceed to form a self-doping type conductive polymer with the polymer chains thereof being crosslinked therebetween on a surface of the dielectric film. The obtained capacitor elements were subjected to evaluation of characteristics in the same manner as in Example 1. Tables 1 and 2 show the results.

### Example 5

One of the portions the size of 3.5 mm×5 mm (cathode formed portion) of the chemically formed aluminum foil wherein a masking was provided in the same way as in Example 1 was treated in the same way as in Example 1 and the cut portion thereof was chemically formed to form a dielectric oxidized film. Then, the chemically formed portion was dipped in Conductive Composition 4 for 5 seconds and dried at room temperature for 5 minutes and then dehydrocondensation reaction was performed at 200° C. for 30 minutes to allow crosslinking to proceed to form a self-doping type conductive polymer with the polymer chains thereof being crosslinked therebetween on a surface of the dielectric film (Step 1).

Total 30 capacitors were completed in the same manner as in Example 1 except that this operation was repeated once again.

The obtained capacitor elements were subjected to evaluation of characteristics in the same manner as in Example 1. Tables 1 and 2 show the results.

### Example 6

One of the portions the size of 3.5 mm×5 mm (cathode formed portion) of the chemically formed aluminum foil wherein a masking was provided in the same way as in Example 1 was treated in the same way as in Example 1 and the cut portion thereof was chemically formed to form a dielectric oxidized film. Then, total 30 capacitors were completed in the same manner as in Example 1 except that a chemically formed portion was dipped in Conductive Composition 5 for 5 seconds and dried at room temperature for 5 minutes and then dehydrocondensation reaction was performed at 200° C. for 30 minutes to allow crosslinking to proceed to form a self-doping type conductive polymer with the polymer chains thereof being crosslinked therebetween on a surface of the dielectric film. The obtained capacitor elements were subjected to evaluation of characteristics in the same manner as in Example 1. Tables 1 and 2 show the results.

### Example 7

One of the portions the size of 3.5 mm×5 mm (cathode formed portion) of the chemically formed aluminum foil wherein a masking was provided in the same way as in Example 1 was treated in the same way as in Example 1 and the cut portion thereof was chemically formed to form a dielectric oxidized film. Then, total 30 capacitors were completed in the same manner as in Example 1 except that a chemically formed portion was dipped in Conductive Composition 6 for 5 seconds and dried at room temperature for 5 minutes and then dehydrocondensation reaction was performed at 200° C. for 30 minutes to allow crosslinking to proceed to form a self-doping type conductive polymer with the polymer chains thereof being crosslinked therebetween on a surface of the dielectric film. The obtained capacitor elements were subjected to evaluation of characteristics in the same manner as in Example 1. Tables 1 and 2 show the results.

### Comparative Example 1

Total 30 capacitors were completed in the same manner as in Example 1 except that a 3 m×4 mm portion of the aluminum foil with a dielectric material film prepared in the same manner as in Example 1 was not subjected to Step 1 that included coating with Conductive Composition 1 and performing dehydrocondensation reaction. The obtained capacitor elements were subjected to evaluation of characteristics in the same manner as in Example 1. Tables 1 and 2 show the results.

### Comparative Example 2

A conductive composition was prepared by adding 95.0 g of ultrapure water to 5.0 g of poly(2-methoxy-5-sulfo-1,4-iminophenylene synthesized referring to the method described in Japanese Patent Application Laid-open No. 7-196791.

A 3 mm×4 mm portion of the aluminum foil with a dielectric material film prepared in the same manner as in Example 1 was dipped in the obtained conductive composition for 5 seconds and dried at room temperature for 5 minutes, and then heated at 300° C. for 15 minutes to release sulfonate groups to form a water-insoluble self-doping type conductive polymer on a surface of the dielectric material film (Step 1). The covered portion of the obtained aluminum foil was dipped in pure water for 1 hour but no elution of the self-doping type conductive polymer was observed. Subsequently, Step 2 and Step 3 were repeated in the same manner as in Example 1 to form solid electrolyte layer.

Then, re-chemical-forming, coating of carbon paste and silver paste, lamination, connection of cathode lead terminal, sealing with epoxy resin, and aging operations were carried out in the same manner as in Example 1 to thereby complete total 30 capacitors. The obtained capacitor elements were subjected to evaluation of characteristics in the same manner as in Example 1. Tables 1 and 2 show the results.

TABLE 1

| | Initial Characteristics | | | | |
|---|---|---|---|---|---|
| | | | | Leakage | |
| | Capacity | Loss | | Current | Defective |
| Example | μF | Coefficient % | ESR Ω | μA | Fraction |
| Example 1 | 101 | 1.1 | 0.014 | 0.28 | 0/30 |
| Example 2 | 103 | 1.0 | 0.015 | 0.22 | 0/30 |
| Example 3 | 102 | 1.1 | 0.014 | 0.24 | 0/30 |
| Example 4 | 103 | 1.2 | 0.019 | 0.25 | 0/30 |
| Example 5 | 102 | 1.1 | 0.015 | 0.22 | 0/30 |
| Example 6 | 104 | 1.0 | 0.016 | 0.21 | 0/30 |
| Example 7 | 103 | 1.1 | 0.015 | 0.24 | 0/30 |
| Comparative | 98 | 3.6 | 0.030 | 0.35 | 1/30 |
| Example 1 | | | | | |
| Comparative | 99 | 3.9 | 0.040 | 0.38 | 8/30 |
| Example 2 | | | | | |

TABLE 2

| | Initial Characteristics | | | | |
|---|---|---|---|---|---|
| | | | | Leakage | |
| | Capacity | Loss | | Current | Defective |
| Example | μF | Coefficient % | ESR Ω | μA | Fraction |
| Example 1 | 101 | 1.1 | 0.014 | 0.28 | 0/20 |
| Example 2 | 103 | 1.0 | 0.015 | 0.22 | 0/20 |
| Example 3 | 102 | 1.1 | 0.014 | 0.24 | 0/20 |
| Example 4 | 103 | 1.2 | 0.019 | 0.25 | 0/20 |
| Example 5 | 102 | 1.1 | 0.015 | 0.22 | 0/20 |
| Example 6 | 104 | 1.0 | 0.016 | 0.21 | 0/20 |
| Example 7 | 103 | 1.1 | 0.015 | 0.24 | 0/20 |
| Comparative | 98 | 3.6 | 0.030 | 0.35 | 2/20 |
| Example 1 | | | | | |
| Comparative | 99 | 3.9 | 0.040 | 0.38 | 3/20 |
| Example 2 | | | | | |

### Example 8

In Step 1 of Example 1, 30 mg of Conductive Composition 1 was injected by coating by means of syringe discharge in a width of 1 mm on of the portions the size of 3.5 mm×5 mm (cathode formed portion) of the chemically formed aluminum foil adjacent to a masking, and then dried for 5 minutes at room temperature. Subsequently, dehydrocondensation reaction was performed at 300° C. for 15 minutes to allow crosslinking to proceed to form a self-doping type conductive polymer with the polymer chains thereof being crosslinked therebetween on a surface of the dielectric film. Total 30 capacitors were completed in the same manner as in Example 1. The obtained capacitor elements were subjected to evaluation of initial characteristics and characteristics after reflow in the same manner as in Example 1. Tables 3 and 4 show the results.

### Example 9

In Step 1 of Example 1, 30 mg of Conductive Composition 2 was injected by coating by means of syringe discharge in a width of 1 mm on one of the portions the size of 3.5 mm×5 mm (cathode formed portion) of the chemically formed aluminum foil adjacent to a masking, and then dried for 5 minutes at room temperature. Subsequently, dehydrocondensation reaction was performed at 300° C. for 15 minutes to allow crosslinking to proceed to form a self-doping type conductive polymer with the polymer chains thereof being crosslinked therebetween on a surface of the dielectric film. Total 30 capacitors were completed in the same manner as in Example 1. The obtained capacitor elements were subjected to evaluation of initial characteristics and characteristics after reflow in the same manner as in Example 1. Tables 3 and 4 show the results.

### Example 10

In Step 1 of Example 1, 30 mg of Conductive Composition 5 was injected by coating by means of syringe discharge in a width of 1 mm on one of the portions the size of 3.5 mm×5 mm (cathode formed portion) of the chemically formed aluminum foil adjacent to a masking, and then dried for 5 minutes at room temperature. After the foil was further dried at 90° C. for 30 minutes, dehydrocondensation reaction was performed at 160° C. for 30 minutes to allow crosslinking to proceed to form a self-doping type conductive polymer with the polymer chains thereof being crosslinked therebetween on a surface of the dielectric film. Total 30 capacitors were completed in the same manner as in Example 1. The obtained capacitor elements were subjected to evaluation of initial characteristics and characteristics after reflow in the same manner as in Example 1. Tables 3 and 4 show the results.

### Comparative Example 3

Chemically formed aluminum foil was cut to pieces of a size of 3.5 mm along short axis direction x 11 mm along long axis direction. A polyimide solution was coated on both sides of the foil in a width of 1.5 mm circumferentially such that the foil is sectioned into two 5 mm and 4.5 mm portions along the long axis direction and dried to form masking. One side (a cathode formed portion) of the chemically formed foil thus obtained was dipped in 10 mass % aqueous ammonium adipate solution and the cut portion was chemically formed by applying a voltage of 3.8 V to form a dielectric material oxide film. Total 30 capacitors were completed in the same manner as in Example 1. The obtained capacitor elements were subjected to evaluation of initial characteristics and characteristics after reflow in the same manner as in Example 1. Tables 3 and 4 show the results.

TABLE 3

| | Characteristics after reflow | | | | |
|---|---|---|---|---|---|
| | | | | Leakage | |
| | Capacity | Loss | | Current | Defective |
| Examples | μF | Coefficient % | ESR Ω | μA | Fraction |
| Example 8 | 103 | 1.1 | 0.009 | 0.23 | 0/30 |
| Example 9 | 103 | 1.0 | 0.009 | 0.19 | 0/30 |
| Example 10 | 102 | 1.1 | 0.011 | 0.20 | 0/30 |
| Comparative | 87 | 3.3 | 0.016 | 0.27 | 1/30 |
| Example 3 | | | | | |

TABLE 4

| | Characteristics after reflow | | | | |
|---|---|---|---|---|---|
| | | | | Leakage | |
| | Capacity | Loss | | Current | Defective |
| Examples | μF | Coefficient % | ESR Ω | μA | Fraction |
| Example 8 | 104 | 1.1 | 0.014 | 0.26 | 0/20 |
| Example 9 | 103 | 1.0 | 0.015 | 0.20 | 0/20 |
| Example 10 | 103 | 1.1 | 0.018 | 0.22 | 0/20 |
| Comparative | 88 | 3.4 | 0.021 | 0.31 | 1/20 |
| Example 3 | | | | | |

### INDUSTRIAL APPLICABILITY

The present invention enables to stably produce thin capacitor elements suitable for laminated type solid electrolytic capacitors, showing less short-circuit failure and less fluctuation in the shape of element, which allows to increase the number of laminated elements in a solid electrolytic capacitor chip to make a capacitor having a high capacity, and having less fluctuation in equivalent series resistance.

1. A solid electrolytic capacitor comprising a layer of self-doping type conductive polymer having a crosslink between polymer chains thereof on the dielectric film formed on a valve-acting metal.

2. The solid electrolytic capacitor as claimed in claim 1, wherein the self-doping type conductive polymer contains a sulfonate group.

3. The solid electrolytic capacitor as claimed in claim 2, wherein the crosslinks are formed through sulfone bonds and the self-doping type conductive polymer contains a crosslinked structure through a sulfone bond in an amount of 0.01 to 90 mol % based on repeating units of the polymer.

4. The solid electrolytic capacitor as claimed in any one of claims 1 to 3, wherein the self-doping type conductive polymer is a self-doping type conductive polymer having a sulfonate group in which the polymer chains are crosslinked through a bond having a binding energy that is by 0.5 to 2 eV lower than the binding energy of the sulfonate group as measured by an X-ray photoelectron spectroscopy.

5. The solid electrolytic capacitor as claimed in any one of claims 1 to 4, wherein the self-doping type conductive polymer contains isothianaphthene skeleton having a sulfonate group.

6. The solid electrolytic capacitor as claimed in claim 5, wherein the self-doping type conductive polymer contains a crosslinked structure through a sulfone bond, represented by general formula (1): 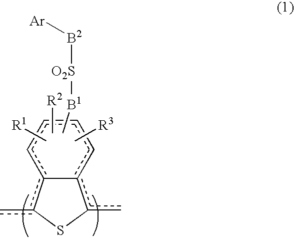
wherein R¹ to R³ independently represent a hydrogen atom, a linear or branched alkyl group having 1 to 20 carbon atoms, a linear or branched alkoxy group having 1 to 20 carbon atoms, a linear or branched alkenyl group having 2 to 20 carbon atoms, a linear or branched alkenyloxy group having 2 to 20 carbon atoms, a hydroxy group, a halogen atom, a nitro group, a cyano group, a trihalomethyl group, a phenyl group, a substituted phenyl group, or a —B¹—SO³⁻M⁺ group; B¹ and B² independently represent —(CH₂)ₚ—(O)_{q}—(CH₂)ᵣ—; p and r independently represent 0 or an integer of 1 to 3; q represents 0 or 1; M⁺ represents a hydrogen ion, an alkali metal ion, or a quaternary ammonium ion; Ar represents a monovalent aromatic group, a substituted monovalent aromatic group, a monovalent heterocyclic group or a substituted monovalent heterocyclic group, which may contain polymer chains.

7. The solid electrolytic capacitor as claimed in claim 6, wherein the self-doping type conductive polymer contains a crosslinked structure through a sulfone bond, represented by general formula (2): 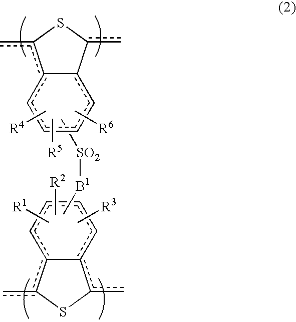
wherein R¹ to R⁶ independently represent a hydrogen atom, a linear or branched alkyl group having 1 to 20 carbon atoms, a linear or branched alkoxy group having 1 to 20 carbon atoms, a linear or branched alkenyl group having 2 to 20 carbon atoms, a linear or branched alkenyloxy group having 2 to 20 carbon atoms, a hydroxy group, a halogen atom, a nitro group, a cyano group, a trihalomethyl group, a phenyl group, a substituted phenyl group, or a —B¹—SO³⁻M⁺ group; B¹ and B² independently represent —(CH₂)ₚ—(O)_{q}—(CH₂)ᵣ—; p and r independently represent 0 or an integer of 1 to 3; q represents 0 or 1; M⁺ represents a hydrogen ion, an alkali metal ion, or a quaternary ammonium ion.

8. The solid electrolytic capacitor as claimed in claim 7, wherein the self-doping type conductive polymer contains a crosslinked structure through a sulfone bond, represented by general formula (3): 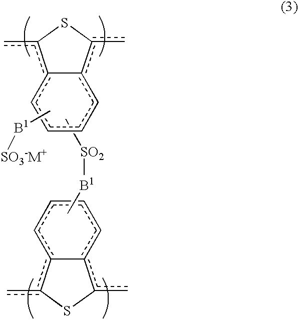
wherein B¹ represents —(CH₂)ₚ—(O)_{q}—(CH₂)ᵣ—; p and r independently represent 0 or an integer of 1 to 3; q represents 0 or 1; M⁺ represents a hydrogen ion, an alkali metal ion, or a quaternary ammonium ion).

9. The solid electrolytic capacitor as claimed in any one of claims 2 to 4, wherein the self-doping type conductive polymer contains a 5-membered heterocyclic skeleton having a sulfonate group.

10. The solid electrolytic capacitor as claimed in claim 9, wherein the self-doping type conductive polymer contains a crosslinked structure through a sulfone bond, represented by general formula (4): 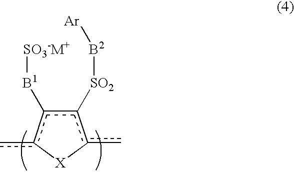
wherein X represents —S—, —O—, or —N(—R¹⁵)—; R¹⁵ represents a hydrogen atom, a linear or branched alkyl group having 1 to 20 carbon atoms, or a linear or branched alkenyl group having 2 to 20 carbon atoms; B¹ and B² independently represent —(CH₂)ₚ—(O)_{q}—(CH₂)ᵣ—; p and r independently represent 0 or an integer of 1 to 3; q represents 0 or 1; M⁺ represents a hydrogen ion, an alkali metal ion, or a quaternary ammonium ion); Ar represents a monovalent aromatic group, a substituted monovalent aromatic group, a monovalent heterocyclic group or a substituted monovalent heterocyclic group, which may contain polymer chains.

11. The solid electrolytic capacitor as claimed in claim 10, wherein the self-doping type conductive polymer contains a crosslinked structure through a sulfone bond, represented by general formula (5): 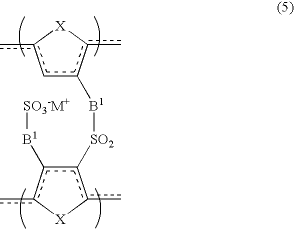
wherein X represents —S—, —O—, or —N(—R¹⁵)—; R¹⁵ represents a hydrogen atom, a linear or branched alkyl group having 1 to 20 carbon atoms, or a linear or branched alkenyl group having 2 to 20 carbon atoms; B¹ represents —(CH₂)ₚ—(O )_{q}—(CH₂)ᵣ—; p and r independently represent 0 or an integer of 1 to 3; q represents 0 or 1; M⁺ represents a hydrogen ion, an alkali metal ion, or a quaternary ammonium ion.

12. The solid electrolytic capacitor as claimed in claim 10. 10 or 11, wherein the self-doping type conductive polymer contains a crosslinked structure through a sulfone bond, represented by general formula (6): 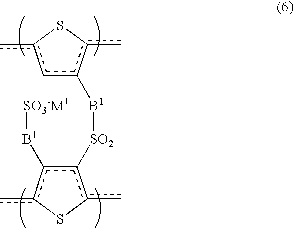
wherein B¹ represents —(CH₂)ₚ—(O)_{q}—(CH₂)ᵣ—; p and r independently represent 0 or an integer of 1 to 3; q represents 0 or 1; M⁺ represents a hydrogen ion, an alkali metal ion, or a quaternary ammonium ion.

13. The solid electrolytic capacitor as claimed in any one of claims 1 to 12, wherein the solid electrolyte layer comprises a first solid electrolyte layer formed on the dielectric layer that is formed on the valve-acting metal and containing the self-doping type conductive polymer having a crosslink between polymer chains, and a second solid electrolyte layer on the first solid electrolyte layer.

14. The solid electrolytic capacitor as claimed in claim 13, wherein the first solid electrolyte layer is water-insoluble.

15. The solid electrolytic capacitor as claimed in any one of claims 1 to 14, wherein the metal is a valve-acting metal having pores.

16. The solid electrolytic capacitor as claimed in claim 15, comprising an insulating material provided to ensure the insulation between an anode and a cathode, and a first solid electrolyte layer containing self-doping type conductive polymer having crosslink between polymer chains on at least a part of the dielectric film on the side of a cathode adjacent to the insulating material, and a second solid electrolyte layer on the first solid electrolyte layer.

17. The solid electrolytic capacitor as claimed in any one of claims 1 to 16, wherein the solid electrolyte layer containing the self-doping type conductive polymer having a crosslink between polymer chains has a film thickness within a range of 1 nm to 1,000 nm.

18. The solid electrolytic capacitor as claimed in any one of claims 1 to 17, wherein the solid electrolyte layer containing the self-doping type conductive polymer having a crosslink between polymer chains has an electric conductivity within a range of 0.001 to 100 S/cm.

19. The solid electrolytic capacitor as claimed in any one of claims 1 to 18, wherein the solid electrolyte layer containing the self-doping type conductive polymer having a crosslink between polymer chains has a pencil hardness of from HB to 4H.

20. A method of producing a solid electrolytic capacitor, the solid electrolytic capacitor being as claimed in any one of claims 1 to 19, comprising coating a film of a dielectric material with self-doping type conductive polymers each containing a chemical structure represented by general formula (7): 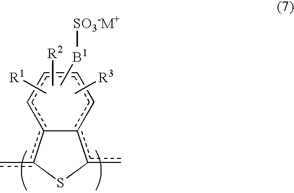
wherein R¹ to R³ independently represent a hydrogen atom, a linear or branched alkyl group having 1 to 20 carbon atoms, a linear or branched alkoxy group having 1 to 20 carbon atoms, a linear or branched alkenyl group having 2 to 20 carbon atoms, a linear or branched alkenyloxy group having 2 to 20 carbon atoms, a hydroxy group, a halogen atom, a nitro group, a cyano group, a trihalomethyl group, a phenyl group, a substituted phenyl group, or a —B¹SO³⁻M⁺ group, provided that any one of R¹ to R³ is a hydrogen atom; B¹ represents —(CH₂)ₚ—(O)_{q}—(CH₂)ᵣ—; p and r independently represent 0 or an integer of 1 to 3; q represents 0 or 1; M⁺ represents a hydrogen ion, an alkali metal ion, or a quaternary ammonium ion), and dehydrocondensing the self-doping type conductive polymers to coat the film of the dielectric material with the self-doping type conductive polymer having a crosslink between the polymer chains, represented by general formula (1) as described in claim 6.

21. A method of producing a solid electrolytic capacitor as claimed in any one of claims 1 to 19, comprising coating a film of a dielectric material with self-doping type conductive polymers each containing a chemical structure represented by general formula (7) and/or general formula (8): 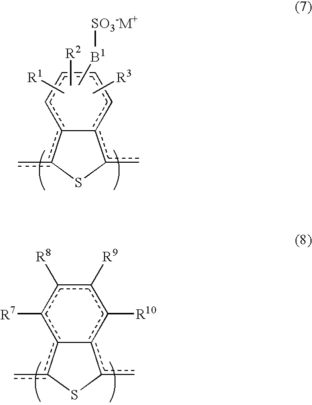
wherein R¹ to R³, B¹ and M⁺ in formula (7) have the same meanings as in general formula (7) described in claim 20, R⁷ to R¹⁰ in formula (8) independently represent a hydrogen atom, a linear or branched alkyl group having 1 to 20 carbon atoms, a linear or branched alkoxy group having 1 to 20 carbon atoms, a linear or branched alkenyl group having 2 to 20 carbon atoms, a linear or branched alkenyloxy group having 2 to 20 carbon atoms, a hydroxy group, a halogen atom, a nitro group, a cyano group, a trihalomethyl group, a phenyl group, a substituted phenyl group, or a —B¹—SO³⁻M⁺ group, provided that, when dehydrocondensing the self-doping type conductive polymers containing the chemical structure represented by formulae (7) and (8), any one of R⁷ to R¹⁰ is a hydrogen atom and none of R¹ to R³ in formula (7) may be a hydrogen atom; when dehydrocondensing the self-doping type conductive polymers containing the chemical structure represented by formula (8), any one of R⁷ to R¹⁰ is a —B¹—SO³⁻M⁺ group, and at least one of R⁷ to R¹⁰ is a hydrogen atom; B¹ represents —(CH₂)ₚ—(O)_{q}—(CH₂)ᵣ—; p and r independently represent 0 or an integer of 1 to 3; q represents 0 or 1; M⁺ represents a hydrogen ion, an alkali metal ion, or a quaternary ammonium ion), and dehydrocondensing the self-doping type conductive polymers to coat the film of the dielectric material with the self-doping type conductive polymer having a crosslink between the polymer chains, represented by general formula (1) as described in claim 6.

22. A method of producing a solid electrolytic capacitor as claimed in any one of claims 1 to 19, comprising coating a film of a dielectric material with a self-doping type conductive polymer obtained by (co)polymerizing monomer(s) represented by general formula (9): 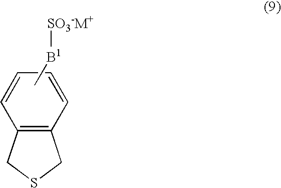
wherein B¹ represents —(CH₂)ₚ—(O)_{q}—(CH₂)ᵣ—; p and r independently represent 0 or an integer of 1 to 3; q represents 0 or 1; M⁺ represents a hydrogen ion, an alkali metal ion, or a quaternary ammonium ion), and dehydrocondensing the self-doping type conductive polymer to coat the film of the dielectric material with the self-doping type conductive polymer having a crosslink between the polymer chains, represented by general formula (3) as described in claim 8.

23. A method of producing a solid electrolytic capacitor, the solid electrolytic capacitor being as claimed in any one of claims 1 to 19, comprising coating a film of a dielectric material with self-doping type conductive polymers each containing a chemical structure represented by general formula (10): 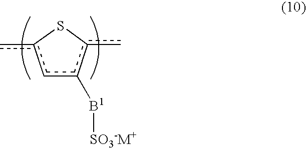
wherein B¹ represents —(CH₂)ₚ—(O)_{q}—(CH₂)ᵣ—; p and r independently represent 0 or an integer of 1 to 3; q represents 0 or 1; M⁺ represents a hydrogen ion, an alkali metal ion, or a quaternary ammonium ion), and dehydrocondensing the self-doping type conductive polymers to coat the film of the dielectric material with the self-doping type conductive polymers having a crosslink between the polymer chains, represented by general formula (6) as described in claim 12.

24. A method of producing a solid electrolytic capacitor, the solid electrolytic capacitor being as claimed in any one of claims 1 to 19, comprising coating a film of a dielectric material with a self-doping type conductive polymer obtained by (co)polymerizing monomer(s) represented by general formula (11): 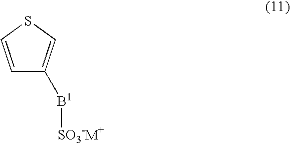
wherein M⁺ represents a hydrogen ion, an alkali metal ion, or a quaternary ammonium ion, and dehydrocondensing the self-doping type conductive polymer to coat the film of the dielectric material with the self-doping type conductive polymer having a crosslink between the polymer chains, represented by general formula (6) as described in claim 12.

25. A method of producing a solid electrolytic capacitor as claimed in any one of claims 1 to 19, comprising dipping a valve-acting metal having pores in a solution containing a self-doping type conductive polymer represented by general formula (7) and/or a self-doping type conductive polymer represented by general formula (8): 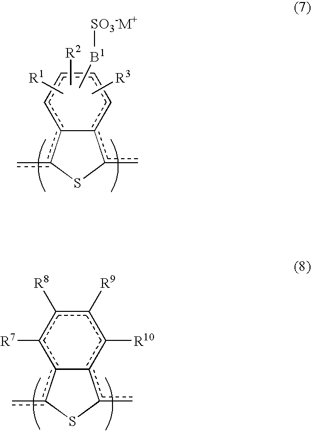
wherein R¹ to R³ and R⁷ to R¹⁰, B¹ and M⁺ in formulae (7) and (8) have the same meanings as in general formulae (7) and (8) described in claim 21, and heating the dipped valve-acting metal to dehydrocondense the self-doping type conductive polymer(s).

26. A method of producing a solid electrolytic capacitor as claimed in any one of claims 1 to 19, comprising coating a solution containing a self-doping type conductive polymer represented by general formula (7) and/or a self-doping type conductive polymer represented by general formula (8): 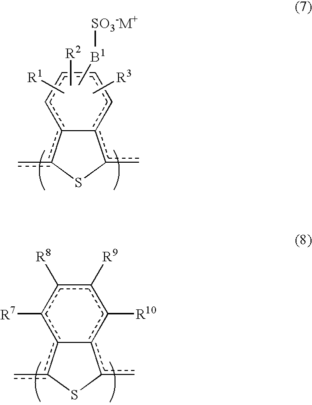
wherein R¹ to R³ and R⁷ to R¹⁰, B¹ and M⁺ in formulae (7) and (8) have the same meanings as in general formulae (7) and (8) described in claim 21, and heating the coated valve-acting metal to dehydrocondense the self-doping type conductive polymer(s).

27. A method of producing a solid electrolytic capacitor as claimed in any one of claims 1 to 19, comprising, in a capacitor comprising an insulating material to ensure the insulation between an anode and a cathode in a valve-acting metal having fine pores, coating at least a part of the dielectric film on the side of a cathode adjacent to the insulating material with a solution containing a self-doping type conductive polymer represented by general formula (7) and/or a self-doping type conductive polymer represented by general formula (8): 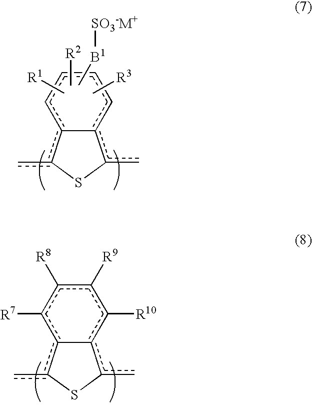
wherein R¹ to R³ and R⁷ to R¹⁰, B¹ and M⁺ in formulae (7) and (8) have the same meanings as in general formulae (7) and (8) described in claim 21, and heating the coated valve-acting metal to dehydrocondense the self-doping type conductive polymer(s).

28. A method of producing a solid electrolytic capacitor as claimed in any one of claims 1 to 19, comprising coating a valve-acting metal having pores with a solution containing a self-doping type conductive polymer obtained by (co)polymerizing a monomer represented by general formula (9): 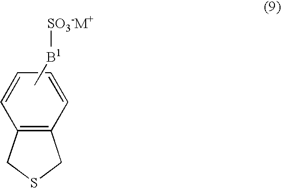
wherein B¹ and M⁺ have the same meanings as in general formulae (9) described in 22), and heating the coated valve-acting metal to dehydrocondense the self-doping type conductive polymer(s).

29. A method of producing a solid electrolytic capacitor as claimed in any one of claims 1 to 19, comprising dipping a valve-acting metal having pores in a solution containing a self-doping type conductive polymer obtained by (co)polymerizing a monomer represented by general formula (9): 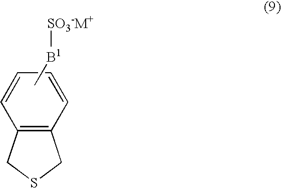
wherein B¹ and M⁺ have the same meanings as in general formula (9) described in 22, and heating the dipped valve-acting metal to dehydrocondense the self-doping type conductive polymer.

30. A method of producing a solid electrolytic capacitor as claimed in any one of claims 1 to 19, comprising, in a capacitor comprising an insulating material to ensure the insulation between an anode and a cathode in a valve-acting metal having fine pores, coating at least a part of the dielectric film on the side of a cathode adjacent to the insulating material with a solution containing a self-doping type conductive polymer obtained by (co)polymerizing a monomer represented by general formula (9): 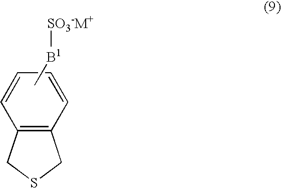
wherein B¹ and M⁺ have the same meanings as in general formulae (9) described in claim 22, and heating the coated valve-acting metal to dehydrocondense the self-doping type conductive polymer.

31. The method of producing a solid electrolytic capacitor, as claimed in any one of claims 20 to 22 and 25 to 30, wherein the dehydrocondensing reaction is performed by heating at a temperature within a range of 210° C. to 350° C.

32. The method of producing a solid electrolytic capacitor, as claimed in claim 23 or 24, wherein the dehydrocondensing reaction is performed by heating at a temperature of 120 to 250° C. for 10 seconds to 60 minutes.

33. A method of producing a solid electrolytic capacitor as claimed in any one of claims 1 to 19, comprising the steps of: dipping a valve-acting metal having a dielectric material film layer in a solution containing a self-doping type conductive polymer which is capable of forming crosslink between the polymer chains, curing the self-doping type conductive polymer by dehydrocondensation reaction to cover the dielectric material film layer with a first solid electrolyte layer that is water-insoluble (step 1); dipping the resultant in a solution containing a monomer which forms a second solid electrolyte layer and then drying (step 2); and dipping the resultant in a solution containing an oxidizer and then drying (step 3) to provide a second solid electrolyte layer on the first solid electrolyte layer.

34. The method of producing a solid electrolytic capacitor as claimed in claim 33, comprising repeating a plurality of times a cycle consisting of the steps of:
dipping a valve-acting metal having a dielectric material film layer in a solution containing a self-doping type conductive polymer which is capable of forming crosslink between the polymer chains, curing the self-doping type conductive polymer by dehydrocondensation reaction to cover the dielectric material film layer with a first solid electrolyte layer that is water-insoluble (step 1); dipping the resultant in a solution containing a monomer which forms a second solid electrolyte layer and then drying (step 2); and dipping the resultant in a solution containing an oxidizer and then drying (step 3) respectively to provide second solid electrolyte layers on the first solid electrolyte layers.

35. The method of producing a solid electrolytic capacitor, as claimed in claim 33, comprising repeating a plurality of times a cycle consisting of the steps of: coating a valve-acting metal having a dielectric material film layer with a solution containing a self-doping type conductive polymer which is capable of forming crosslink between the polymer chains, curing the self-doping type conductive polymer by dehydrocondensation reaction to cover the dielectric material film layer with a first solid electrolyte layer that is water-insoluble (step 1); dipping the resultant in a solution containing a monomer which forms a second solid electrolyte layer and then drying (step 2); and dipping the resultant in a solution containing an oxidizer and then drying (step 3) respectively to provide second solid electrolyte layers on the first solid electrolyte layers.

36. The method of producing a solid electrolytic capacitor as claimed in any one of claims 33 to 35, wherein the oxidizer is a persulfate.

37. The method of producing a solid electrolytic capacitor as claimed in any one of claims 33 to 36, wherein the solution containing the oxidizer is a suspension that contains organic fine particles.

38. The method producing a solid electrolytic capacitor as claimed in claim 37, wherein the organic fine particles have an average particle diameter (D₅₀) within a range of 1 to 20 μm.

39. The method of producing a solid electrolytic capacitor as claimed in claim 38, wherein the organic particles are particles of at least one compound selected from the group consisting of aliphatic sulfonic acid compounds, aromatic sulfonic acid compounds, aliphatic carboxylic acid compounds, aromatic carboxylic acid compounds, salts thereof, and peptide compounds.

40. A solid electrolytic capacitor produced by the production method as claimed in any one of claims 20 to 39.
